(19) United States
(12) Patent Application Publication
(10) Pub. No.: US 2025/0149727 A1
(43) Pub. Date: May 8, 2025

(54) CELL COVER MEMBER AND BATTERY MODULE INCLUDING THE SAME

(71) Applicants: HYUNDAI MOTOR COMPANY, SEOUL (KR); KIA CORPORATION, SEOUL (KR)

(72) Inventors: Hyun Chang KANG, Hwaseong-si (KR); Yu Ri OH, Hwaseong-si (KR); Jun Young KANG, Hwaseong-si (KR); Sun Keun PARK, Hwaseong-si (KR); Ji Woong JUNG, Hwaseong-si (KR); In Gook SON, Hwaseong-si (KR)

(21) Appl. No.: 18/937,425

(22) Filed: Nov. 5, 2024

(30) Foreign Application Priority Data
Nov. 6, 2023 (KR) 10-2023-0151998

(51) Int. Cl. H01M 50/342; H01M 10/658; H01M 50/155; H01M 50/244; H01M 50/289; H01M 50/367

(52) U.S. Cl. CPC H01M 50/3425; H01M 10/658; H01M 50/155; H01M 50/244; H01M 50/289; H01M 50/367

(57) ABSTRACT

A battery module is provided that includes a battery cell including a first battery cell and a second battery cell distinguished from the first battery cell, a module frame that forms a cell accommodating part in which the battery cell is accommodated, and a cell cover member that forms a venting portion that discharges a fluid generated from the first battery cell from one side of the first battery cell in a vertical direction to the outside of the cell accommodating part.

### CROSS-REFERENCE TO RELATED APPLICATION

This application claims the benefit of priority to Korean Patent Application No. 10-2023-0151998, filed in the Korean Intellectual Property Office on Nov. 6, 2023, the entire contents of which are incorporated herein by reference.

### TECHNICAL FIELD

The present disclosure relates to a cell cover member and a battery module including the same, and more particularly, relates to a battery module for delaying thermal runaway.

### BACKGROUND

In recent years, research and development on electric vehicles, which are environmentally-friendly vehicles, has been emphasized as crisis awareness of environments and oil resource depletion has increased. The electric vehicles include a plug-in hybrid electric vehicle (PHEV), a battery electric vehicle (BEV), a fuel cell electric vehicle (FCEV), and the like.

An electric vehicle may include a battery module and a battery housing supporting the battery module. Meanwhile, the electric vehicle uses battery cells of the battery module as a power source, and when a fire occurs in the battery module, there is a risk of thermal runaway.

Accordingly, there is a need for a battery module capable of reducing heat transfer in the battery module that causes thermal runaway when a fire occurs in the battery module.

### SUMMARY

The present disclosure has been made to solve the above-mentioned problems occurring in the prior art while maintaining advantages intact.

An aspect of the present disclosure provides a battery module for venting a high-temperature gas caused by a fire occurring in a battery cell to the outside of the battery module.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery module includes a battery cell including a first battery cell and a second battery cell distinguished from the first battery cell, a module frame that forms a cell accommodating part in which the battery cell is accommodated, and a cell cover member that forms a venting portion that discharges a fluid generated from the first battery cell from one side of the first battery cell in a vertical direction to the outside of the cell accommodating part.

The cell cover member may include a cover body that supports the first battery cell and a cover part disposed to cover the one side of the first battery cell in the vertical direction and formed to be cut off from the cover body by pressure of the fluid generated from the first battery cell.

The cover body may include a blocking part disposed between the first battery cell and the second battery cell to separate the first battery cell and the second battery cell from each other.

The cell cover member may further include a guide cutoff portion that extends along a periphery of the cover part.

The cell cover member may further include a first guide cutoff portion that is provided on the cover part and that extends in a first direction and a second guide cutoff portion that extends in a second direction crossing the first direction.

The cell cover member may further include a guide cutoff portion that is provided on the cover body and that extends in a lengthwise direction of the cover body.

The battery module may further include a fireproof cover member that is provided on one side of the cell cover member in the vertical direction and that forms a guide portion that discharges a fluid generated from the battery cell from the one side of the cell cover member in the vertical direction to the outside of the cell accommodating part.

The fireproof cover member may form the guide portion when a fireproof cover part disposed on the one side of the cell cover member in the vertical direction and formed to be cut by pressure of the fluid generated from the battery cell is cut.

The fireproof cover member may further include a fireproof guide cutoff portion that extends in a lengthwise direction of the fireproof cover part or in a circumferential direction of the fireproof cover part.

The guide portion may include a hole formed in the fireproof cover member.

A thickness of the cell cover member in the vertical direction or a horizontal direction may be smaller than a thickness of the fireproof cover member in the vertical direction or the horizontal direction.

The battery cell may further include a third battery cell provided on an opposite side to the second battery cell with respect to the first battery cell in a horizontal direction and covered by the cover body together with the first battery cell. The cover body may include a first blocking part disposed between the first battery cell and the second battery cell and a second blocking part that corresponds to the first blocking part and covers an opposite side of the third battery cell opposite to one side of the third battery cell that faces toward the first battery cell.

A support member may be provided between the first battery cell and the third battery cell.

The support member may be implemented with a surface pressure member or a fireproof sheet.

The cell cover member may include a first cell cover member that supports the first battery cell and a second cell cover member that supports the second battery cell disposed on one side of the first battery cell that faces in a horizontal direction. The second cell cover member may be provided on one side of the first cell cover member in the horizontal direction. A support member may be disposed between the first cell cover member and the second cell cover member.

The module frame may further include a first side frame and a second side frame disposed parallel to each other to horizontally apply pressure to the battery cell from opposite sides of the battery cell that face in a horizontal direction.

The cell cover member may be disposed between the first side frame and the second side frame and may cover an upper side of the first battery cell, and an upper side of the cell cover member may be open.

The battery cell may further include a third battery cell provided on an opposite side to the second battery cell with respect to the first battery cell in a horizontal direction. The cell cover member may include a blocking part disposed between the first battery cell and the third battery cell to separate the first battery cell and the third battery cell from each other and a cell opening formed such that one surface of the first battery cell that faces toward the second battery cell is open.

The cover body may further include a base part that connects the first blocking part and the second blocking part and covers an opposite side of the first battery cell in the vertical direction.

The cover body may include a first cover part that extends from the blocking part to cover the one side of the first battery cell in the vertical direction and a second cover part that extends from the blocking part to cover one side of the second battery cell in the vertical direction.

The battery module may further include a sensing board disposed between the module frame and the battery cell and a partition wall disposed between the module frame and the sensing board.

The partition wall may be connected to the sensing board and may extend from the sensing board toward the module frame.

The partition wall may be connected to the module frame and may extend from the module frame toward the sensing board.

A fireproof pad or a fireproof material may be provided between the module frame and the battery cell.

According to another aspect of the present disclosure, a cell cover member includes a cover body that supports a first battery cell and a cover part connected to the cover body. To prevent a fluid generated from the first battery cell from flowing to a second battery cell distinguished from the first battery cell, the cover part is separated from the cover body by pressure of the fluid to form a venting portion that discharges the fluid to the outside of the cover body.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a battery module according to one embodiment of the present disclosure;

FIG. 2 is a side sectional view of the battery module taken along line I-I′ illustrated in FIG. 1 according to one embodiment of the present disclosure;

FIG. 3 is a perspective view of a cell cover member covering a first battery cell and a third battery cell according to one embodiment of the present disclosure;

FIG. 4 is a side sectional view of the cell cover member taken along line II-II′ illustrated in FIG. 3;

FIG. 5 is a side sectional view of a cell cover member according to another embodiment of the present disclosure;

FIG. 6 is a plan view of the cell cover member according to one embodiment of the present disclosure;

FIG. 7 is a plan view of a cell cover member according to another embodiment of the present disclosure;

FIG. 8 is a plan view of a cell cover member according to another embodiment of the present disclosure;

FIG. 9 is a plan view of a cell cover member according to another embodiment of the present disclosure;

FIG. 10 is a plan view of a cell cover member according to another embodiment of the present disclosure;

FIG. 11 is a side sectional view of the cell cover member according to one embodiment of the present disclosure;

FIG. 12 is a side sectional view of a cell cover member according to another embodiment of the present disclosure;

FIG. 13 is a side sectional view of a cell cover member according to another embodiment of the present disclosure;

FIG. 14 is a side sectional view of a cell cover member according to another embodiment of the present disclosure;

FIG. 15 is a side sectional view of a cell cover member according to another embodiment of the present disclosure;

FIG. 16 is a side sectional view of a battery module according to another embodiment of the present disclosure;

FIG. 17 is a perspective view of a cell cover member according to another embodiment of the present disclosure;

FIG. 18 is a side sectional view of the cell cover member according to the other embodiment of the present disclosure illustrated in FIG. 17;

FIG. 19 is a side sectional view of some components of a battery module according to another embodiment of the present disclosure;

FIG. 20 is a side sectional view of a cell cover member according to another embodiment of the present disclosure;

FIG. 21 is a side sectional view of some components of a battery module according to another embodiment of the present disclosure;

FIG. 22 is a side sectional view of a cell cover member according to another embodiment of the present disclosure;

FIG. 23 is a side sectional view of a cell cover member according to another embodiment of the present disclosure;

FIG. 24 is a side sectional view of a cell cover member according to another embodiment of the present disclosure;

FIG. 25 is a side sectional view of a cell cover member according to another embodiment of the present disclosure;

FIG. 26 is a perspective view of a cell cover member according to another embodiment of the present disclosure;

FIG. 27 is a plan view of the cell cover member according to the embodiment of the present disclosure illustrated in FIG. 26;

FIG. 28 is a side sectional view of the cell cover member according to the embodiment of the present disclosure illustrated in FIG. 26;

FIG. 29 is a side sectional view of some components of a battery module according to another embodiment of the present disclosure;

FIG. 30 is a side sectional view of some components of a battery module according to another embodiment of the present disclosure;

FIG. 31 is a side sectional view of some components of a battery module according to another embodiment of the present disclosure;

FIG. 32 is a side sectional view of some components of a battery module according to another embodiment of the present disclosure;

FIG. 33 is a side sectional view of a cell cover member according to another embodiment of the present disclosure;

FIG. 34 is a side sectional view of some components of a battery module according to another embodiment of the present disclosure;

FIG. 35 is a schematic view illustrating a fireproof cover member and a cell cover member of the battery module according to another embodiment of the present disclosure;

FIG. 36 is a schematic view illustrating the fireproof cover member and the cell cover member illustrated in FIG. 35;

FIG. 37 is a schematic view illustrating a fireproof cover member and a cell cover member of a battery module according to another embodiment of the present disclosure;

FIG. 38 is a schematic view illustrating the fireproof cover member and the cell cover member illustrated in FIG. 37;

FIG. 39 is a schematic view illustrating a fireproof cover member and a cell cover member of a battery module according to another embodiment of the present disclosure;

FIG. 40 is a schematic view illustrating the fireproof cover member and the cell cover member illustrated in FIG. 39;

FIG. 41 is a schematic view illustrating a fireproof cover member and a cell cover member of a battery module according to another embodiment of the present disclosure;

FIG. 42 is a schematic view illustrating the fireproof cover member and the cell cover member illustrated in FIG. 41;

FIG. 43 is a schematic view illustrating a fireproof cover member and a cell cover member of a battery module according to another embodiment of the present disclosure;

FIG. 44 is a schematic view illustrating a fireproof cover member and a cell cover member of a battery module according to another embodiment of the present disclosure;

FIG. 45 is a schematic view illustrating the fireproof cover member and the cell cover member illustrated in FIG. 44;

FIG. 46 is a schematic view of the battery module according to another embodiment of the present disclosure;

FIG. 47 is a schematic view of a front end portion of the battery module illustrated in FIG. 46;

FIG. 48 is a schematic view of a front end portion of a battery module according to another embodiment of the present disclosure;

FIG. 49 is a schematic view of a front end portion of a battery module according to another embodiment of the present disclosure;

FIG. 50 is a schematic view of a front end portion of a battery module according to another embodiment of the present disclosure;

FIG. 51 is a schematic view of a front end portion of a battery module according to another embodiment of the present disclosure;

FIG. 52 is a schematic view of a front end portion of a battery module according to another embodiment of the present disclosure;

FIG. 53 is a schematic view of a front end portion of a battery module according to another embodiment of the present disclosure;

FIG. 54 is a schematic view of a front end portion of a battery module according to another embodiment of the present disclosure;

FIG. 55 is a schematic view illustrating a coupling structure of a fireproof pad and a third side frame illustrated in FIG. 54;

FIG. 56 is a schematic view illustrating another coupling structure of the fireproof pad and the third side frame illustrated in FIG. 54;

FIG. 57 is a perspective view of a battery module according to another embodiment of the present disclosure;

FIG. 58 is a side sectional view of the battery module illustrated in FIG. 57;

FIG. 59 is a schematic view illustrating a state in which a cover part is separated from a cover body due to a fire occurring in a first battery cell of the battery module according to one embodiment of the present disclosure and heat transfer from the first battery cell to a second battery cell adjacent thereto is prevented;

FIG. 60 is a schematic view illustrating a state in which a cover part is separated from a cover body due to a fire occurring in a first battery cell of the battery module according to one embodiment of the present disclosure and heat transfer from the first battery cell to a second battery cell adjacent thereto is prevented;

FIG. 61 is a schematic view of a battery pack system that prevents a flame occurring in a first battery module from being introduced into a second battery module according to one embodiment of the present disclosure;

FIG. 62 is a side sectional view of the battery pack system that prevents the flame occurring in the first battery module from being introduced into the second battery module according to one embodiment of the present disclosure;

FIG. 63 is a side sectional view of a battery pack system that prevents a flame occurring in a first battery module from being introduced into a second battery module according to another embodiment of the present disclosure;

FIG. 64 is a side sectional view of a cell cover member inserted into a gap filler according to another embodiment of the present disclosure; and

FIG. 65 is a side sectional view of a cell cover member inserted into a gap filler according to another embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

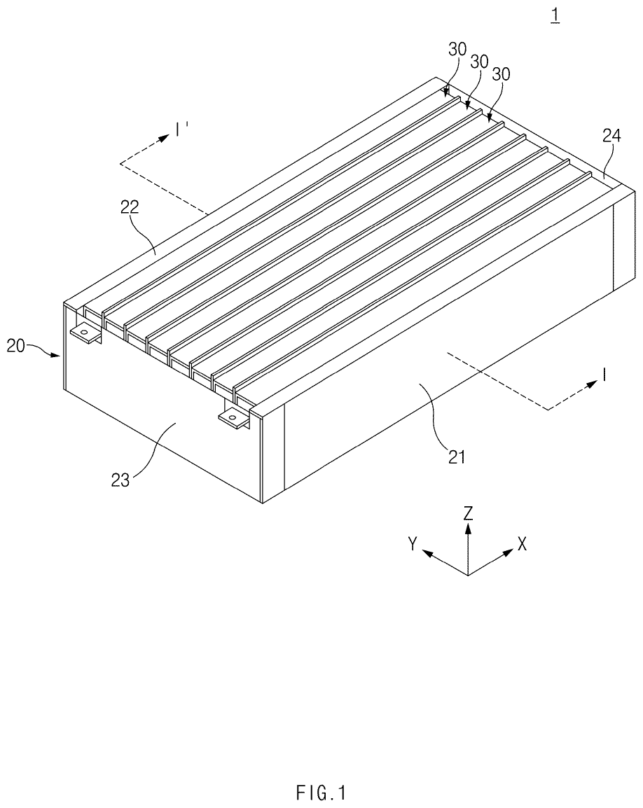

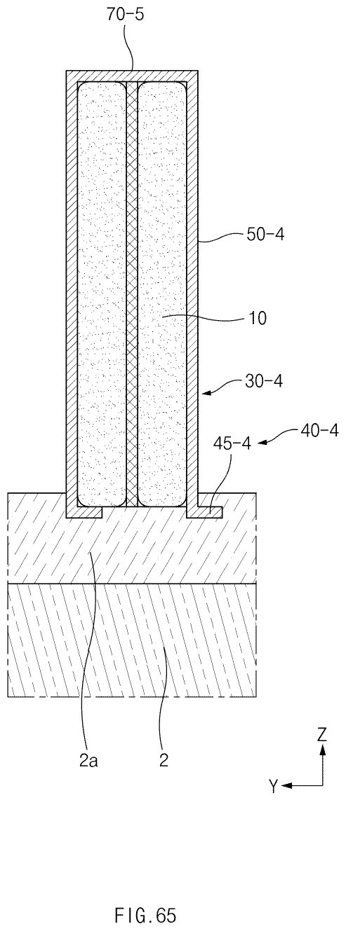

Hereinafter, embodiments of the present disclosure will be described in detail with reference to FIGS. 1 to 65.

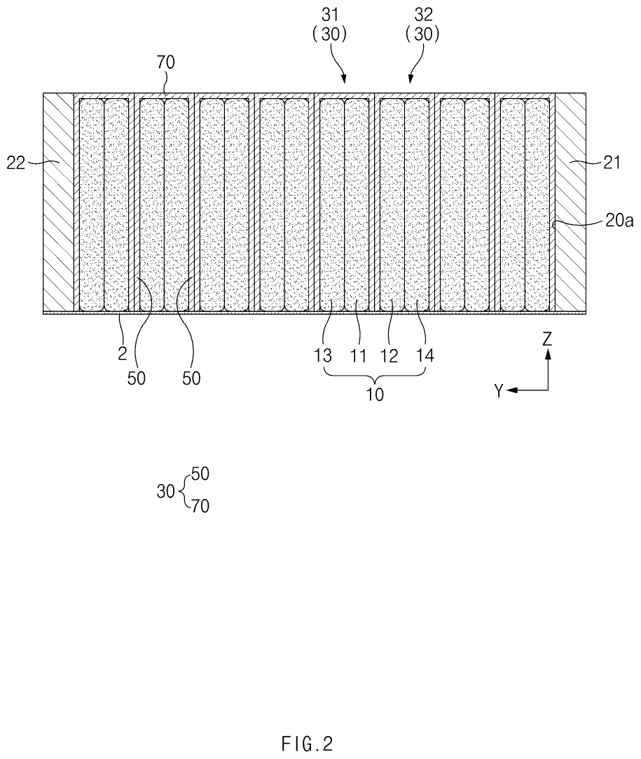

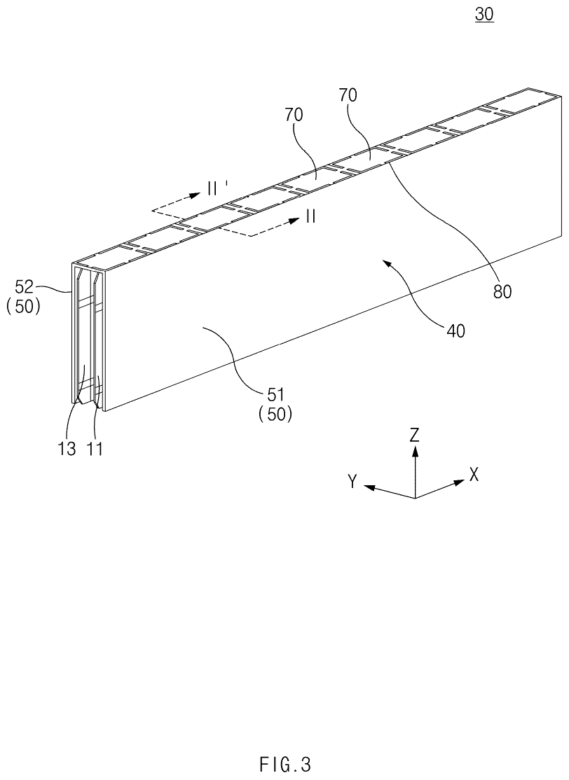

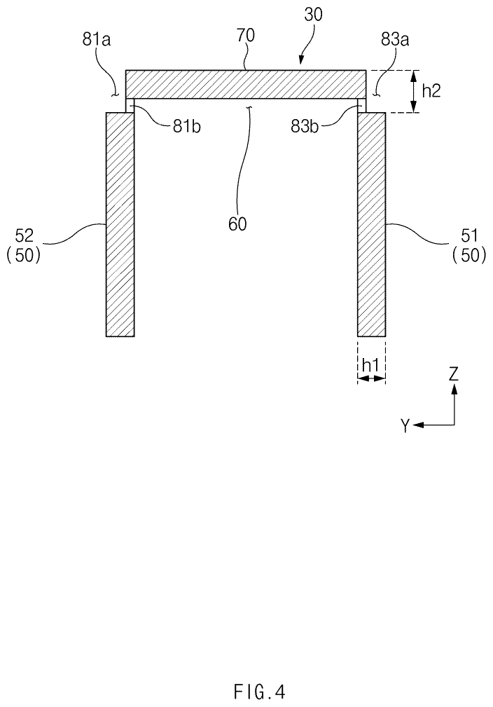

FIG. 1 is a perspective view of a battery module 1 according to one embodiment of the present disclosure. FIG. 2 is a side sectional view of the battery module 1 taken along line I-I′ illustrated in FIG. 1 according to one embodiment of the present disclosure. FIG. 3 is a perspective view of a cell cover member 30 covering a first battery cell 11 and a third battery cell 13 according to one embodiment of the present disclosure. FIG. 4 is a side sectional view of the cell cover member taken along line II-II′ illustrated in FIG. 3.

Referring to FIGS. 1 to 4, the battery module 1 may be a component that accommodates a plurality of battery cells 10 and covers the plurality of battery cells 10 from the outside. The battery module 1 may include the plurality of battery cells 10 and a module frame 20 that forms a cell accommodating part 20a in which the plurality of battery cells 10 are accommodated.

The plurality of battery cells 10 may extend in a first direction (the X direction) that is a horizontal direction and may be arranged in a second direction (the Y direction) that is a direction perpendicular to the first direction. The battery cells 10 may be implemented with lithium-ion batteries. However, without being limited thereto, the battery cells 10 may be implemented with all-solid batteries. Hereinafter, the first direction (the X direction) and the second direction (the Y direction) may be a first direction in a horizontal direction and a second direction in a direction perpendicular to the first direction, respectively.

The module frame 20 may cover the plurality of battery cells 10. The module frame 20 may include a first side frame 21 disposed on a side facing in the direction (the −Y direction) opposite to the second direction with respect to the plurality of battery cells 10 and a second side frame 22 disposed on a side facing in the second direction (the Y direction) with respect to the plurality of battery cells 10.

In addition, the module frame 20 may include a third side frame 23 disposed on a side facing in the direction (the X direction) opposite to the first direction with respect to the plurality of battery cells 10 and a fourth side frame 24 disposed on a side facing in the first direction (the X direction) with respect to the plurality of battery cells 10.

The first side frame 21 and the second side frame 22 may be formed to correspond to each other and may extend parallel to each other. The third side frame 23 and the fourth side frame 24 may be formed to correspond to each other and may extend parallel to each other. A base plate 2 may be provided on the lower sides of the first to fourth side frames 21, 22, 23, and 24 to cover the lower sides of the battery cells 10.

The battery module 1 may include a plurality of cell cover members 30. Each of the cell cover members 30 may support at least one battery cell 10. The cell cover member 30 may cover the upper side of the at least one battery cell 10. The cell cover member 30 may extend in the first direction (the X direction) to cover the upper side of the at least one battery cell 10. The plurality of cell cover members 30 may be arranged in the second direction (the Y direction).

Unlike an upper cover that covers the upper side of the battery module 1, the plurality of cell cover members 30 may be mounted between the first side frame 21 and the second side frame 22.

As will be described below, the cell cover members 30 may be understood to be components for forming venting portions 60 that discharge, from the upper sides of the battery cells 10 to the outside of the cell accommodating part 20a, a fluid (more specifically, a high-temperature gas) generated in the battery cells 10 in which a fire occurs.

The battery cells 10 may include the first battery cell 11, a second battery cell 12 disposed parallel to the first battery cell 11 and adjacent to the first battery cell 11, and the third battery cell 13 provided on the opposite side to the second battery cell 12 with respect to the first battery cell 11. Hereinafter, the first battery cell 11 or the third battery cell 13 may be understood as a battery call in which a fire occurs, and the second battery cell 12 may be understood as a battery cell for preventing heat transfer due to the fire in the first battery cell 11 or the third battery cell 13. The first battery cell 11 and the second battery cell 12 may be covered by different cell cover members 30. That is, the cell cover members 30 may include a first cell cover member 31 that covers the upper side of the first battery cell 11 and a second cell cover member 32 that covers the upper side of the second battery cell 12.

As illustrated in FIG. 2, each of the cell cover members 30 may cover a pair of battery cells 10. In other words, the first cell cover member 31 may cover the first battery cell 11 and the third battery cell 13 disposed on the opposite side to the second battery cell 12 with respect to the first battery cell 11, and the second cell cover member 32 may cover the second battery cell 12 and a fourth battery cell 14 disposed on the opposite side to the first battery cell 11 with respect to the second battery cell 12. However, the present disclosure is not limited thereto, and it is sufficient for each of the cell cover members 30 to cover at least one battery cell 10.

The first cell cover member 31 may not only cover the upper side of the first battery cell 11, but may also cover the opposite sides of the first battery cell 11 and the third battery cell 13 in a horizontal direction. Likewise, the second cell cover member 32 may not only cover the upper side of the second battery cell 12, but may also cover the opposite sides of the second battery cell 12 and the fourth battery cell 14 in the horizontal direction.

To achieve this structure, each of the first cell cover member 31 and the second cell cover member 32 may include a cover part 70 disposed on one side of the battery cell 10 in the vertical direction and a blocking part 50 that covers one side of the battery cell 10 in the horizontal direction.

However, the Z direction illustrated in the drawings described above or the drawings to be described below may be an upward direction, but may be a downward direction. Accordingly, the cover part 70 may be disposed on the lower side of the battery cell 10 in the vertical direction, and the base plate 2 may be disposed on the upper side of the battery cell 10 in the vertical direction.

The cover part 70, as will be described below, may be a part to be separated when a fire occurs in each battery cell 10, and the blocking part 50 may be a part for preventing heat conduction while separating the first battery cell 11 and the second battery cell 12 from each other to prevent thermal runaway due to heat transfer from a battery cell 10 in which a fire occurs to an adjacent battery cell 10.

Hereinafter, the structure of the cell cover member 30 will be described in detail.

As described above, the cell cover member 30 may cover the pair of battery cells 11 and 13. The cell cover member 40 may include a cover body 40 that supports the first battery cell 11 and the third battery cell 13 and the cover part 70 connected to the cover body 40 to close the venting portion 60 formed to be opened when a fire occurs.

In this case, the cover body 40 may be understood as a structure in which the cover part 70 is excluded from the cell cover member 30.

The cover body 40 may include the blocking part 50 that has a first blocking part 51 covering a side of the first battery cell 11 that faces in the direction opposite to the second direction (the Y direction) and a second blocking part 52 covering a side of the third battery cell 13 that faces in the second direction (the Y direction). The first blocking part 51 may be disposed between the first battery cell 11 and the second battery cell 12, and the second blocking part 52 may correspond to the first blocking part 51 and may cover the third battery cell 13.

The blocking part 50 may extend in the third direction (the Z direction) to separate the first battery cell 11 and the third battery cell 13 from the other battery cells 10 to delay heat transfer to the second battery cell 12 or the battery cell disposed on the side of the third battery cell 13 facing in the second direction (the Y direction) due to a fire occurring in the first battery cell 11 or the third battery cell 13.

Here, the third direction (the Z direction), which is perpendicular to the first direction (the X direction) and the second direction (the Y direction), may be understood as one direction in the vertical, or the up/down direction. That is, the blocking part 50 may extend in the vertical direction to isolate the battery cell 10 surrounded by the cell cover member 30. Accordingly, the first blocking part 51 may be disposed between the first battery cell 11 and the second battery cell 12 and may extend in the vertical direction.

When the first battery cell 11 and the third battery cell 13 operate in an environment in which a fire does not occur in the first battery cell 11 and the third battery cell 13, the cover part 70 of the first cell cover member 31 may be connected to the cover body 40 to cover the upper sides of the first battery cell 11 and the third battery cell 13.

However, when a fire occurs in the first battery cell 11 or the third battery cell 13, the cover part 70 of the first cell cover member 31 may be separated from the cover body 40 and may open portions of the upper sides of the first battery cell 11 and the third battery cell 13. When the cover part 70 is disposed on the lower side of the first cell cover member 31, the cover part 70 of the first cell cover member 31 may be separated from the cover body 40 and may open portions of the lower sides of the first battery cell 11 and the third battery cell 13.

When a fire occurs in the first battery cell 11 and the third battery cell 13, the internal pressure in the cell cover member 30 in which the first battery cell 11 and the third battery cell 13 are accommodated may be raised, and the cover part 70 may be separated from the cover body 40 by the pressure. That is, the cover part 70 may be cut off from the cover body 40 by the pressure of a high-temperature gas generated in the first battery cell 11 or the third battery cell 13.

In other words, the cover part 70 may be connected to the cover body 40, but to prevent a fluid generated in the first battery cell 11 or the third battery cell 13 from flowing to the second battery cell 12, the cover part 70 may be separated from the cover body 40 by the pressure of the fluid to form the venting portion 60 that discharges the fluid generated in the first battery cell 11 or the third battery cell 13 to the outside of the cover body 40.

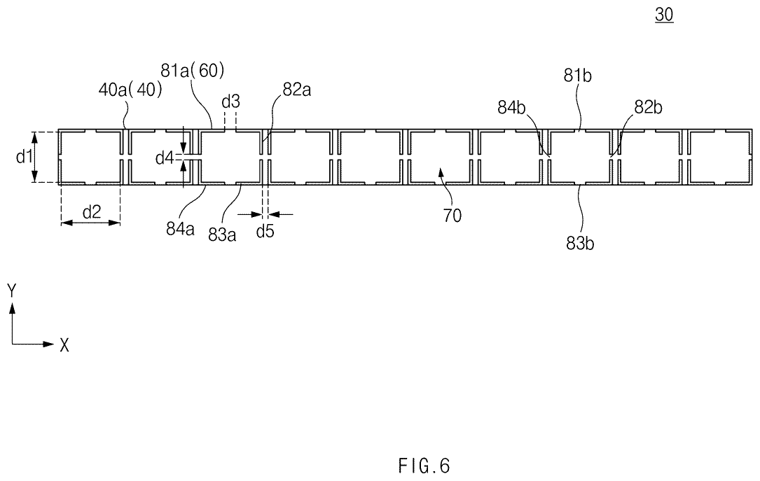

To allow the cover part 70 to be separated from the cover body 40 only when a fire occurs in the first battery cell 11 or the third battery cell 13, unlike when the first battery cell 11 or the third battery cell 13 normally operates, the cell cover member 30 according to one embodiment of the present disclosure may include a guide cutoff portion 80 (refer to FIG. 6) extending along the periphery of the cover part 70.

In addition, as illustrated in FIG. 4, the blocking part 50 and the cover part 70 may be connected through a first guide connecting portion 81b and a third guide connecting portion 83b. In this case, a first guide cut-away portion 81a and a third guide cut-away portion 83a may be provided between the blocking part 50 and the cover part 70, and the depths h2 of the first guide cut-away portion 81a and the third guide cut-away portion 83a in the third direction (the Z direction) may be smaller than or equal to 50% of the thickness h1 of the cell cover member 30. However, the present disclosure is not limited thereto.

According to this structure, the cover part 70 may be separated from the cover body 40 by the pressure of the fluid to form the venting portion 60 when a fire occurs in the first battery cell 11 or the third battery cell 13, and the high-temperature gas generated from the fire may be guided to the outside of the cell accommodating part 20a. Furthermore, the above-described structure, together with the structure of the blocking part 50, may prevent heat transfer from the first battery cell 11 to the second battery cell 12, thereby preventing thermal runaway of the battery module 1.

Moreover, according to the structure, the first side frame 21 and the second side frame 22 disposed parallel to each other may horizontally apply pressure to the battery cells 10 from the opposite sides of the battery cells 10 that face in the horizontal direction.

In addition, according to the structure, the cell cover members 30 may be disposed between the first side frame 21 and the second side frame 22 and may cover the upper sides of the respective battery cells 10. That is, a separate module cover may be unnecessary and accordingly, the upper sides of the cell cover members 30 may be provided to be open.

Hereinabove, the embodiments of the present disclosure have been described, and each of the cell cover members 30 may be understood as a component in which the cover part 70 is separated from the cover body 40 when the guide connecting portions 81b, 82b, 83b, and 84b are cut.

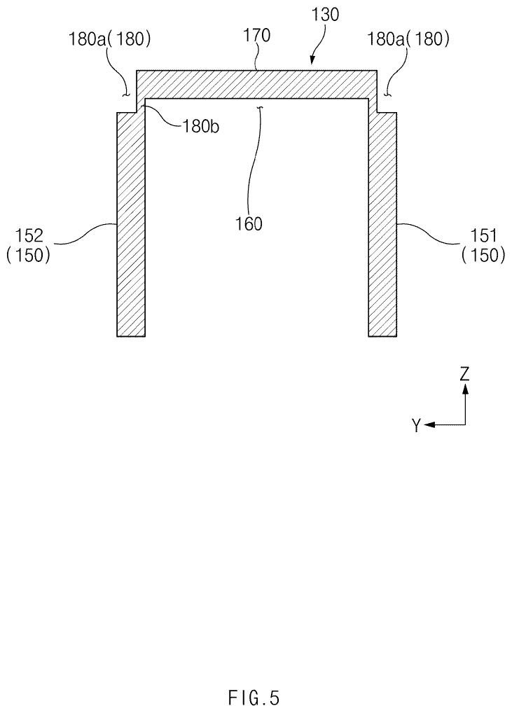

FIG. 5 is a side sectional view of a cell cover member 130 according to another embodiment of the present disclosure.

Unlike that illustrated in FIG. 4, a cover part 170 of the cell cover member 130 according to the other embodiment of the present disclosure may include a guide cutoff portion 180 connected to a blocking part 150 along the periphery of the cover part 170.

Unlike the guide cutoff portion illustrated in FIG. 4, the guide cutoff portion 180 may include a guide separation portion 180b that is relatively thin when compared to the blocking part 150 and that is more easily cut by the pressure in the cell cover member 130 and a separation groove 180a formed by the guide separation portion 180b.

FIG. 6 is a plan view of the cell cover member 30 according to one embodiment of the present disclosure.

The guide cutoff portion 80 may include guide cut-away portions 81a, 82a, 83a, and 84a extending in the circumferential direction of the cover part 70 and spacing the cover part 70 apart from the cover body 40 and the guide connecting portions 81b, 82b, 83b, and 84b connecting the cover part 70 and the cover body 40.

The guide cut-away portions 81a, 82a, 83a, and 84a may include the first guide cut-away portion 81a, the second guide cut-away portion 82a, the third guide cut-away portion 83a, and the fourth guide cut-away portion 84a that are spaced apart from one another in the circumferential direction of the cover part 70.

The guide connecting portions 81b, 82b, 83b, and 84b may include the first guide connecting portion 81b disposed between the first guide cut-away portion 81a and the second guide cut-away portion 82a, the second guide connecting portion 82b disposed between the second guide cut-away portion 82a and the third guide cut-away portion 83a, the third guide connecting portion 83b disposed between the third guide cut-away portion 83a and the fourth guide cut-away portion 84a, and the fourth guide connecting portion 84b disposed between the fourth guide cut-away portion 84a and the first guide cut-away portion 81a.

As illustrated in FIG. 6, the first to fourth guide cut-away portions 81a to 84a may be disposed at four corners of the cover part 70, but are not limited thereto. Likewise, the first to fourth guide connecting portions 81b and 84b may be disposed at the centers of four sides of the cover part 70, but are not limited thereto.

While the first battery cell 11 or the third battery cell 13 is in normal operation, the cover part 70 may remain connected to the cover body 40 by the guide connecting portions 81b, 82b, 83b, and 84b and may cover the upper side of the first battery cell 11 or the third battery cell 13.

In contrast, when a fire occurs in the first battery cell 11 or the third battery cell 13, the guide connecting portions 81b, 82b, 83b, and 84b may be cut by the pressure of the fire occurring in the first battery cell 11 or the third battery cell 13 because the guide connecting portions 81b, 82b, 83b, and 84b are shorter in the circumferential direction of the cover part 70 than the guide cut-away portions 81a, 82a, 83a, and 84a.

A plurality of cover parts 70 may be provided. The plurality of cover parts 70 may be spaced apart from one another in the first direction (the X direction). Due to the plurality of cover parts 70, the area of the venting portion 60 opened by the cover parts 70 separated from the cover body 40 may be varied depending on the explosive force of a fire occurring in the battery cell 10 or the amount of high-pressure gas released from the battery cell 10, and thus thermal runaway may be more efficiently delayed depending on situations.

The width d1 of the cover part 70 in the second direction (the Y direction) may be smaller than the length d2 of the cover part 70 in the first direction (the X direction). The widths d3 of the first guide connecting portion 81b and the third guide connecting portion 83b in the circumferential direction of the cover part 70 may be determined by the length d2 of the cover part 70. In addition, the widths d4 of the second guide connecting portion 82b and the fourth guide connecting portion 84b in the circumferential direction of the cover part 70 may be determined by the width d1 of the cover part 70.

A support part 40a of the cover body 40 may be provided between a pair of cover parts 70 adjacent to each other in the first direction (the X direction). The length d5 of the support part 40a in the first direction (the X direction) may be greater than 5 mm. Due to this structure, other adjacent cover parts 70 may be prevented from being separated together even though the cover part 70 is separated from the cover body 40.

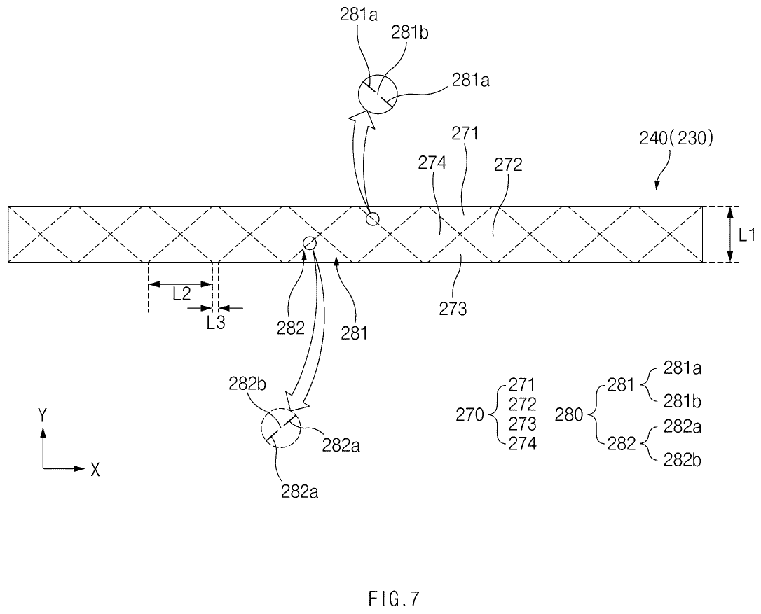

FIG. 7 is a plan view of a cell cover member 230 according to another embodiment of the present disclosure.

Referring to FIG. 7, unlike the cell cover member 30 according to one embodiment of the present disclosure, the cell cover member 230 may have a structure in which a cover part 270 is cut into several portions and cut off from a cover body 240 rather than a structure in which the cover part 270 is separated from the cover body 240.

When the battery cell 10 (refer to FIG. 2) accommodated in the cell cover member 230 normally operates, the cover part 270 may cover the upper side of the battery cell 10 without being cut off from the cover body 240.

When a fire occurs in the battery cell 10 accommodated in the cell cover member 230, the cover part 270 may be cut into several portions, such as a first cover portion 271, a second cover portion 272, a third cover portion 274, and a fourth cover portion 274, by the pressure of a high-pressure gas generated from the fire.

In other words, the cell cover member 230 may include a guide cutoff portion 280 that has a first guide cutoff portion 281 that is provided on the cover part 270 and that extends in the direction opposite to the second direction (the Y direction) with respect to the first direction (the X direction) and a second guide cutoff portion 282 that extends in the second direction (the Y direction) with respect to the first direction (the X direction) to cross the first guide cutoff portion 281.

The first guide cutoff portion 281,
582 and the third guide cutoff portion 583 may cross each other at the one end of the first guide cutoff portion 581.

The cell cover member 530 may include a fourth guide cutoff portion 584 extending from an opposite end of the first guide cutoff portion 581 in the second direction (the Y direction) with respect to the direction opposite to the first direction (the X direction) and a fifth guide cutoff portion 585 extending from the opposite end of the first guide cutoff portion 581 in the direction opposite to the second direction (the Y direction) with respect to the direction opposite to the first direction (the X direction). The fourth guide cutoff portion 584 and the fifth guide cutoff portion 585 may cross each other at the opposite end of the first guide cutoff portion 581.

When a fire occurs in the cell accommodating part 20a, the pressure may be raised, and a cover part 570 may be separated into first to fourth cover parts 571, 572, 573, and 574 to form the venting portion 60.

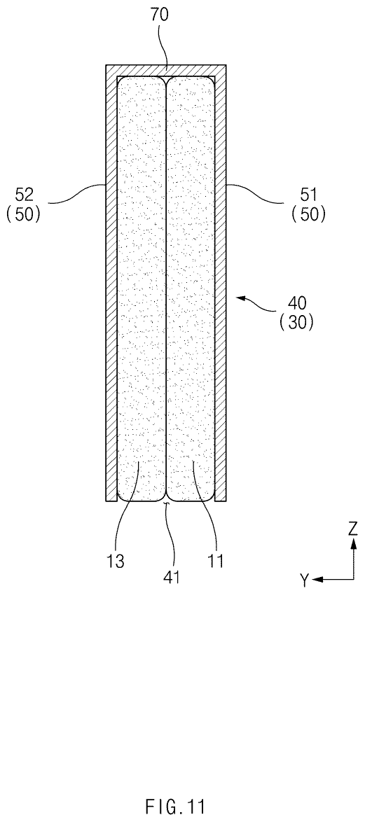

FIG. 11 is a side sectional view of the cell cover member according to one embodiment of the present disclosure.

Referring to FIG. 11, as described above, the cell cover member 30 may cover both the first battery cell 11 and the third battery cell 13. In this case, it may be understood that the second battery cell 12 (refer to FIG. 2) is provided on the opposite side to the third battery cell 13 with respect to the first battery cell 11 in the horizontal direction.

In more detail, the cell cover member 30 may include the first blocking part 51 covering one surface of the first battery cell 11, the second blocking part 52 covering one surface of the third battery cell 13, and the cover part 70 connected to the first blocking part 51 and the second blocking part 52 so as to be easily separated from the first blocking part 51 and the second blocking part 52.

That is, the cover body 40 distinguished from the cover part 70 may include the first blocking part 51 that covers one surface of the first battery cell 11 facing toward the second battery cell 12 to separate the first battery cell 11 from the second battery cell 12 and the second blocking part 52 that corresponds to the first blocking part 51 and covers one surface of the third battery cell 13 facing away from the first battery cell 11.

According to this structure, even though a fire occurs in the first battery cell 11, heat may be transferred only from the first battery cell 11 to the third battery cell 13, and heat transfer to the adjacent second battery cell 12 may be delayed. Thus, safety may be improved.

Meanwhile, the cell cover member 30 may include a cell opening 41 provided below the first battery cell 11 and the third battery cell 13. The lower end of the first blocking part 51 and the lower end of the second blocking part 52 may be spaced apart from each other in the second direction (the Y direction) to form the cell opening 41. In the structure in which the cover part 70 is disposed below the first battery cell 11 and the third battery cell 13, the cell opening 41 may be understood as a structure disposed above the first battery cell 11 and the third battery cell 13.

The cell cover member 30 may be formed of a material having thermal insulation performance or fire resistance performance. The cell cover member 30 may be formed of MICA (mica), a ceramic composite material, or an aerosol composite material. As will be described below, the cell cover member 30 is not limited thereto and may be formed of a metallic material.

According to this structure, although not separately illustrated in the drawing, a cooling channel provided on the base part 2 (refer to FIG. 2) of the battery module 1 may make direct contact with the first battery cell 11 and the third battery cell 13 and may more efficiently cool the first battery cell 11 and the third battery cell 13.

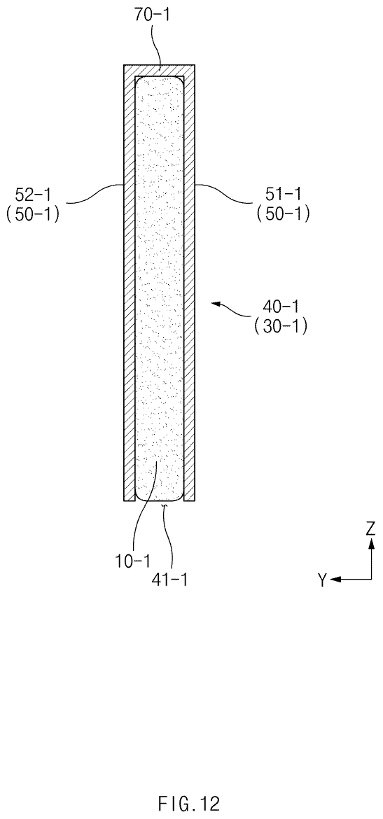

FIG. 12 is a side sectional view of a cell cover member according to another embodiment of the present disclosure.

Referring to FIG. 12, unlike the cell cover member 30 of FIG. 11, the cell cover member 30-1 may cover one battery cell 10-1.

The cell cover member 30-1 may include a first blocking part 51-1 covering one surface of the battery cell 10-1, a second blocking part 52-1 covering an opposite surface of the battery cell 10-1, and a cover part 70-1 connected to the first blocking part 51-1 and the second blocking part 52-1 so as to be easily separated from the first blocking part 51-1 and the second blocking part 52-1.

That is, a cover body 40-1 of the cell cover member 30-1 may include a blocking part 50-1 provided on the opposite sides of the first battery cell 10-1 in the horizontal direction. The cover body 40-1 may include the first blocking part 51-1 disposed between the first battery cell 10-1 and a second battery cell provided on one side of the first battery cell 10-1 in the horizontal direction and the second blocking part 52-1 that corresponds to the first blocking part 51-1 and that is disposed between the first battery cell 10-1 and a third battery cell provided on an opposite side of the first battery cell 10-1 in the horizontal direction.

According to this structure, even when a fire occurs in the first battery cell 10-1, heat transfer to other battery cells adjacent to the first battery cell 10-1 may be delayed, and thus safety may be improved.

Likewise, the cell cover member 30-1 may include a cell opening 41-1 provided below the battery cell 10-1. Accordingly, the battery cell 10-1 may be more efficiently cooled. As described above, the cell opening 41-1 which extends in the direction opposite to the second direction (the Y direction) with respect to the first direction (the X direction), may space the first cover portion 271 apart from the fourth cover portion 274 and may space the second cover portion 272 apart from the third cover portion 273.

The first guide cutoff portion 281 may include a plurality of guide cut-away portions 281a that extend in the direction opposite to the second direction (the Y direction) with respect to the first direction (the X direction) and that are spaced apart from each other and a guide connecting portion 281b provided between the plurality of guide cut-away portions 281a.

The second guide cutoff portion 282, which extends in the second direction (the Y direction) with respect to the first direction (the X direction), may space the first cover portion 271 apart from the second cover portion 272 and may space the third cover portion 273 apart from the fourth cover portion 274. The second guide cutoff portion 282 may include a plurality of guide cut-away portions 282a that extend in the second direction (the Y direction) with respect to the first direction (the X direction) and that are spaced apart from each other and a guide connecting portion 282b provided between the plurality of guide cut-away portions 282a.

With respect to the extension directions of the guide cutoff portions 281 and 282 of FIG. 7, the cover part 270 may be separated into the first to fourth cover portions 271 to 274 to form an open portion.

The first length L1 of the guide cutoff portion 280 in the second direction (the Y direction) and the second length L2 of the guide cutoff portion 280 in the first direction (the X direction) are not limited, but the separation distance L3 between the first guide cutoff portion 281 and the second guide cutoff portion 282 in the first direction (the X direction) may be determined by the first length L1 and the second length L2.

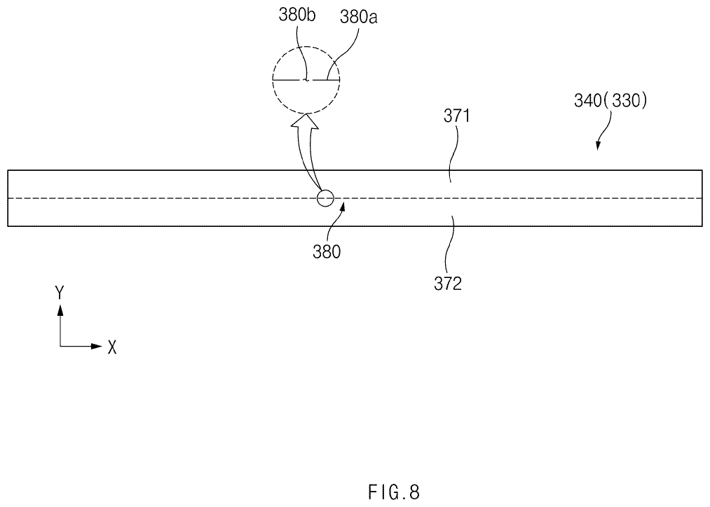

FIG. 8 is a plan view of a cell cover member according to another embodiment of the present disclosure.

Referring to FIG. 8, a cover body 340 of the cell cover member 330 may have a structure in which a cover part 371 and 372 is cut into a first cover part 371 and a second cover part 372.

The cell cover member 330 may include a guide cutoff portion 380 that is provided on the cover body 340 and that extends in the first direction (the X direction) that is the lengthwise direction of the cover body 340. In more detail, the cell cover member 330 may include the guide cutoff portion 380 extending in the first direction (the X direction) along the center of the cover body 340 based on the second direction (the Y direction).

The guide cutoff portion 380 may include guide cut-away portions 380a spaced apart from each other along one straight line and a guide connecting portion 380b provided between the plurality of first guide cutaway portions 380a.

Due to the aforementioned fire, the guide cutoff portion 380 may be cut in the first direction (the X direction) that is the lengthwise direction of the cover body 340, and thus the first cover part 371 and the second cover part 372 may be spaced apart from each other.

Meanwhile, guide cutoff portions in the following drawings as well as FIG. 8 may correspond to a structure implemented with the guide cut-away portions and the guide connecting portions of the above-described guide cutoff portion.

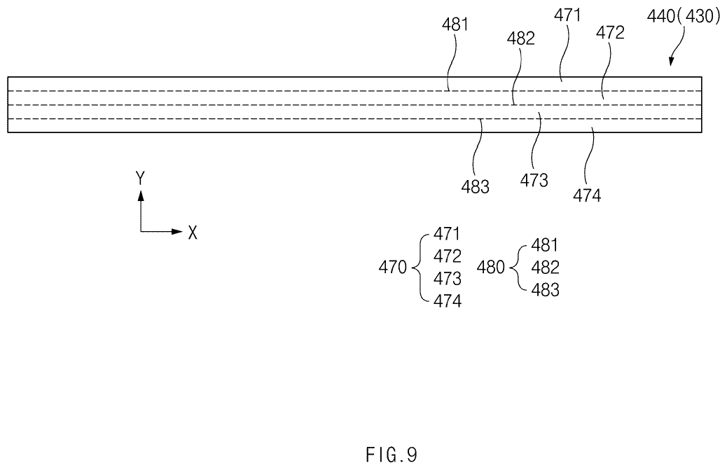

FIG. 9 is a plan view of a cell cover member according to another embodiment of the present disclosure.

Referring to FIG. 9, similarly to the cell cover member 330 in FIG. 8, the cell cover member 430 may include a guide cutoff portion 480 that is provided on a cover body 440 and that extends in the first direction (the X direction) that is the lengthwise direction of the cover body 440.

The guide cutoff portion 480 may include a plurality of guide cutoff portions spaced apart from one another in the second direction (the Y direction) perpendicular to the first direction (the X direction). The guide cutoff portion 480 may include a first guide cutoff portion 481, a second guide cutoff portion 482, and a third guide cutoff portion 483.

The first to third guide cutoff portions 481 to 483 may be spaced apart from one another at equal intervals in the second direction (the Y direction), but are not limited thereto.

A cover part 470 may be separated into first to fourth cover parts 471, 472, 473, and 474 by the first to third guide cutoff portions 481 to 483. That is, in an environment in which the pressure in the cell accommodating part 20a (refer to FIG. 2) due to a fire is relatively strong, the second cover part 472 and the third cover part 473 may be separated from the cover body 440, and the first cover part 471 and the second cover part 472 may be deformed in directions away from each other.

Accordingly, the venting portion 60 (refer to FIG. 4) may be provided in the portion where the first to fourth cover parts 471, 472, 473, and 474 were located.

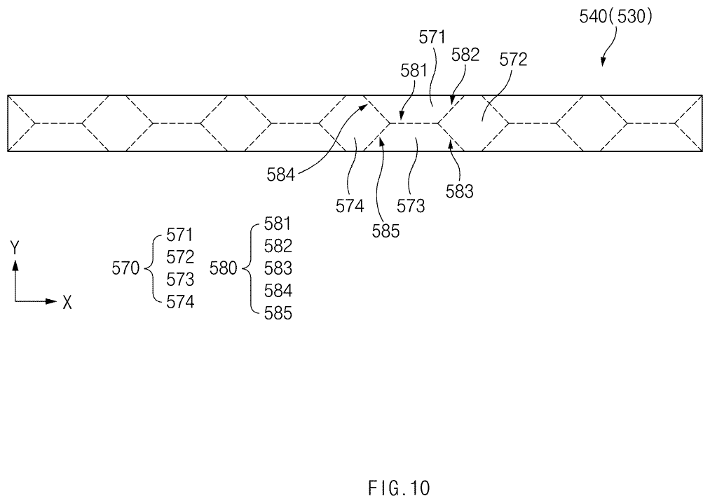

FIG. 10 is a plan view of a cell cover member according to another embodiment of the present disclosure.

Referring to FIG. 10, the cell cover member 530 may include a first guide cutoff portion 581 that is provided on a cell cover body 540 and that extends in the first direction (the X direction), a second guide cutoff portion 582 extending from one end of the first guide cutoff portion 581 in the second direction (the Y direction) with respect to the first direction (the X direction), and a third guide cutoff portion 583 extending from the one end of the first guide cutoff portion 581 in the direction opposite to the second direction (the Y direction) with respect to the first direction (the X direction). The second guide cutoff portion may be provided above the battery cell 10-1.

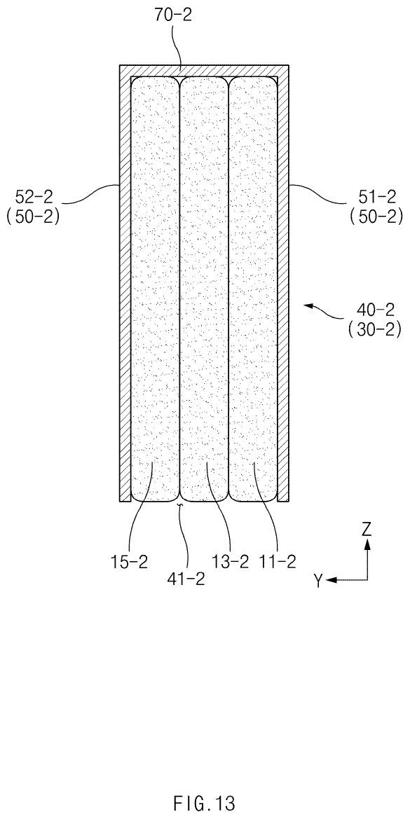

FIG. 13 is a side sectional view of a cell cover member according to another embodiment of the present disclosure.

Referring to FIG. 13, the cell cover member 30-2 may cover a first battery cell 11-2, and a third battery cell 13-2 and a fifth battery cell 15-2 that are disposed on the opposite side to a second battery cell in the horizontal direction with respect to the first battery cell 11-2. In this case, the third battery cell 13-2 may be disposed between the first battery cell 11-2 and the fifth battery cell 15-2.

A cover body 40-2 of the cell cover member 30-2 may cover the first battery cell 11-2, the third battery cell 13-2, and the fifth battery cell 15-2 at the same time and may include a blocking part 50-2 provided on the opposite sides of the first, third, and fifth battery cells 11-2, 13-2, and 15-2 in the horizontal direction.

The cell cover member 30-2 may include a first blocking part 51-2 covering one surface of the first battery cell 11-2 that faces away from the third battery cell 13-2, a second blocking part 52-2 covering one surface of the fifth battery cell 15-2 that faces away from the third battery cell 13-2, and a cover part 70-2 connected to the first blocking part 51-2 and the second blocking part 52-2 so as to be easily separated from the first blocking part 51-2 and the second blocking part 52-2.

Likewise, the cell cover member 30-2 may include a cell opening 41-2 provided below the first battery cell 11-2, the third battery cell 13-2, and the fifth battery cell 15-2. The cooling efficiency of the battery cells 11-2, 13-2, and 15-2 may be further improved by the above-described structure. Alternatively, the cell opening 41-2 may be disposed above the battery cells 11-2, 13-2, and 15-2.

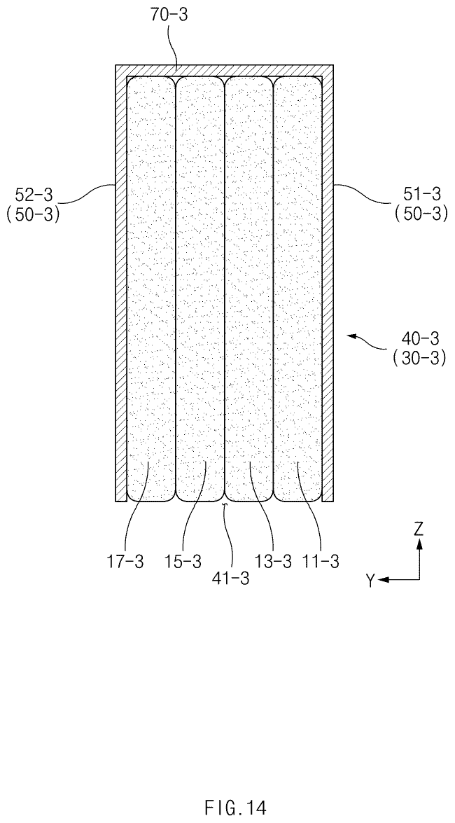

FIG. 14 is a side sectional view of a cell cover member 30-3 according to another embodiment of the present disclosure.

Referring to FIG. 14, the cell cover member 30-3 may cover a total of four battery cells, that is, a first battery cell 11-3, a third battery cell 13-3, a fifth battery cell 15-3, and a seventh battery cell 17-3.

A cover body 40-3 of the cell cover member 30-3 may include a blocking part 50-3 provided on the opposite sides of the four battery cells in the horizontal direction.

The cell cover member 30-3 may include a first blocking part 51-3 covering one surface of the first battery cell 11-3 that faces away from the third battery cell 13-3, a second blocking part 52-3 covering one surface of the seventh battery cell 17-3 that faces away from the fifth battery cell 15-3, and a cover part 70-3 connected to the first blocking part 51-3 and the second blocking part 52-3 so as to be easily separated from the first blocking part 51-3 and the second blocking part 52-3.

In addition, the cell cover member 30-3 may include a cell opening 41-3 defined therein through which the first blocking part 51-3 and the second blocking part 52-3 are open toward the lower side such that the four battery cells 11-3, 13-3, 15-3, and 17-3 make direct contact with a cooling device (not illustrated). Alternatively, the cell opening 41-3 may be provided such that the four battery cells 11-3, 13-3, 15-3, and 17-3 are open upward.

Accordingly, the cooling efficiency of the battery cells 11-3, 13-3, 15-3, and 17-3 may be improved.

Referring to FIGS. 11 to 14, each of the cell cover members 30, 30-1, 30-2, and 30-3 may cover at least one battery cell 10 (refer to FIG. 2). When it is expected that a flame caused by a fire that is likely to occur in the battery cell 10 is relatively small or the pressure of a gas caused by the fire is relatively low, each of the cell cover members 30, 30-1, 30-2, and 30-3 may be provided to cover a relatively large number of battery cells 10.

This is because covering one battery cell 10 is efficient in terms of prevention of heat transfer, but considering that the space in which the battery cells 10 are accommodated is generally limited, it is desirable to improve the density of the battery cells 10.

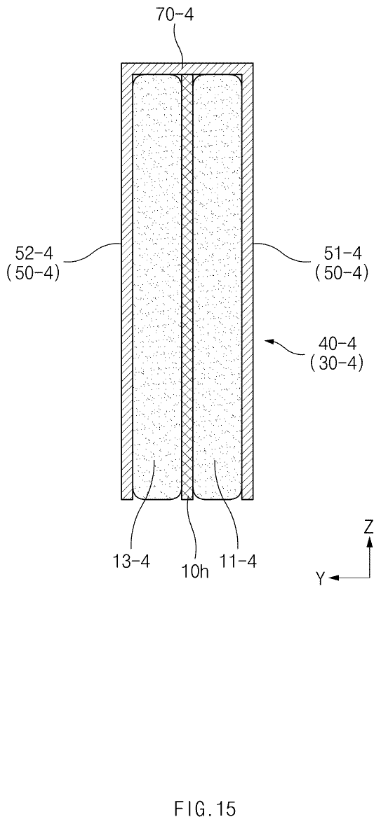

FIG. 15 is a side sectional view of a cell cover member according to another embodiment of the present disclosure.

Referring to FIG. 15, the cell cover member 30-4 may cover a first battery cell 11-4 and a third battery cell 13-4 provided on the opposite side to a second battery cell with respect to the first battery cell 11-4, and a support member 10h may be provided between the first battery cell 11-4 and the third battery cell 13-4. The support member 10h may be implemented with a surface pressure member that applies a force to the first battery cell 11-4 and the third battery cell 13-4 or a fireproof sheet formed of a fireproof material to delay heat transfer between the first battery cell 11-4 and the third battery cell 13-4. Alternatively, the support member 10h may be formed of silicone for simultaneously satisfying thermal insulation and the formation of surface pressure.

According to this structure, the cell cover member 30-4 may surround the plurality of battery cells 11-4 and 13-4. Accordingly, even though a cover part 70-4 is separated from a cover body 40-4 due to a fire, heat transfer that is likely to occur between the battery cells 11-4 and 13-4 in the one cell cover member 30-4 may be more efficiently delayed, and thus a thermal runaway phenomenon may be prevented when a fire occurs in the battery module 1 (refer to FIG. 1).

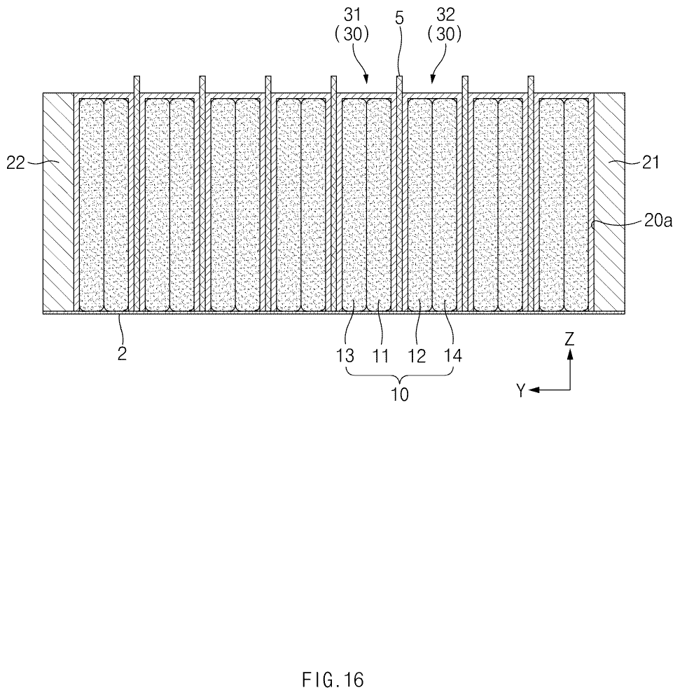

FIG. 16 is a side sectional view of a battery module according to another embodiment of the present disclosure.

Unlike the battery module 1 of FIG. 2, the battery module 1 illustrated in FIG. 16 may further include a support member 5 between a first cell cover member 31 that supports a first battery cell 11 and a second cell cover member 32 that supports a second battery cell 12 and that is provided on one side of the first cell cover member 31. The support member 5 may be implemented with a surface pressure member that applies a force to the first cell cover member 31 and the second cell cover member 32 or a fireproof sheet formed of a fireproof material to delay heat transfer between the first cell cover member 31 and the second cell cover member 32. Alternatively, the support member 5 may be formed of silicone for simultaneously satisfying thermal insulation and the formation of surface pressure.

According to this structure, the support member, together with the cell cover members 30, may further prevent heat transfer from the first battery cell 11 to the second battery cell 12 due to a fire occurring in the first battery cell 11. In addition, the battery cells 10 need to be pressed from opposite sides in the second direction (the Y direction), and this effect may also be achieved due to the support member 5.

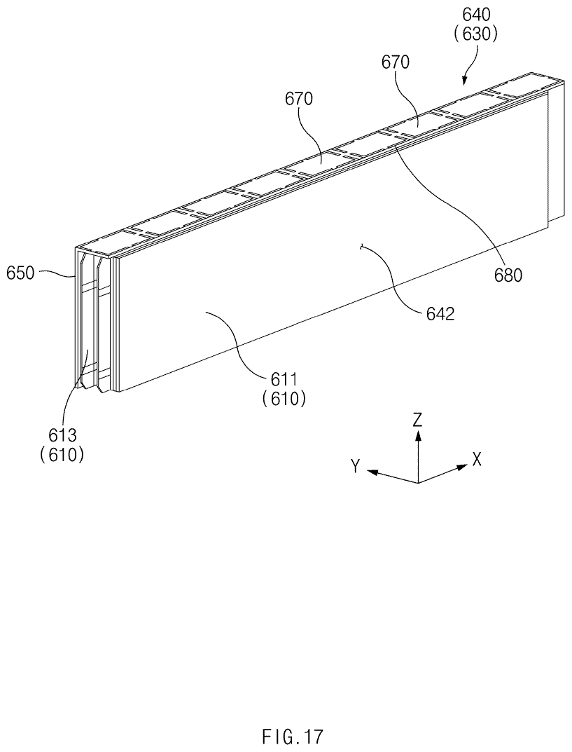

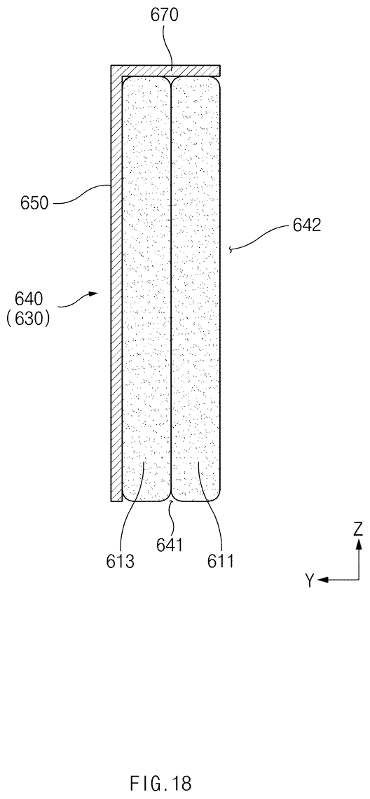

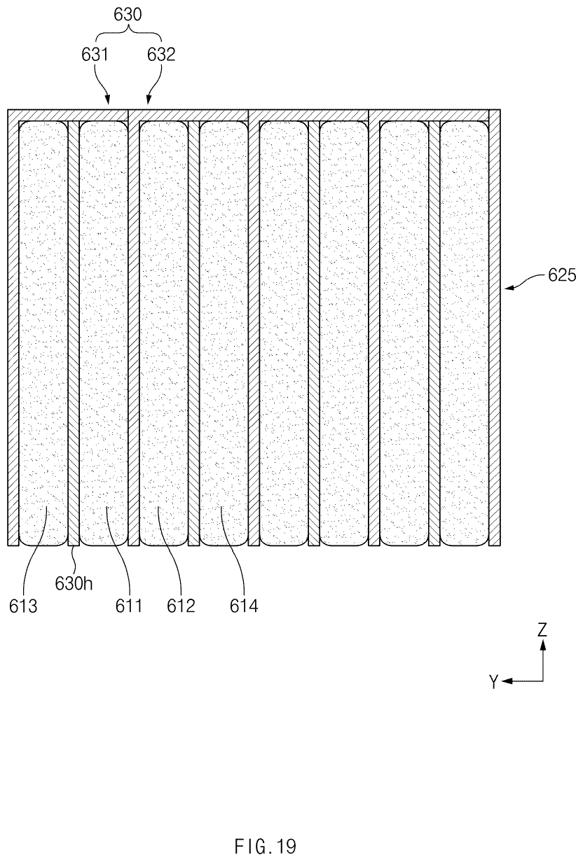

FIG. 17 is a perspective view of a cell cover member according to another embodiment of the present disclosure. FIG. 18 is a side sectional view of the cell cover member according to the other embodiment of the present disclosure illustrated in FIG. 17. FIG. 19 is a side sectional view illustrating some components of a battery module according to another embodiment of the present disclosure.

Referring to FIGS. 17 to 19, the cell cover member 630 may be formed in the shape of “L”. The cell cover member 630 may include a cover part 670 covering one side of at least one battery cell 611 and 613 in the vertical direction (e.g., the Z direction) and a blocking part 650 that is connected to the cover part 670 and that extends in the direction opposite to the third direction (the Z direction) to cover one surface of the at least one battery cell 611 and 613.

Here, a second battery cell 612 may be provided on one side of the first battery cell 611 in the horizontal direction, and the third battery cell 613 may be provided on an opposite side of the first battery cell 611 in the horizontal direction.

The cover part 670 may be easily cut off from a cover body 640 by a guide cutoff portion 680 extending along the periphery of the cover part 670. Accordingly, when a fire occurs in the first battery cell 611 or the third battery cell 613, the cover part 670 may be separated from the cover body 640 by pressure caused by the fire. The resulting effect is as described above.

The cell cover member 630 may include a cell opening 641 provided on the opposite side of the first battery cell 611 and the third battery cell 613 in the vertical direction. When the cover part 670 is provided above the first battery cell 611 and the third battery cell 613, the cell opening 641 may be provided below the first battery cell 611 and the third battery cell 613. Alternatively, when the cover part 670 is provided below the first battery cell 611 and the third battery cell 613, the cell opening 641 may be provided above the first battery cell 611 and the third battery cell 613. The resulting effect is as described above.

The blocking part 650 may cover one surface of one of the first battery cell 611 and the third battery cell 613. The blocking part 650 may extend to cover one surface of the third battery cell 613 that faces away from the first battery cell 611.

In other words, the blocking part 650 may be disposed between the first battery cell 611 and the third battery cell 613 to separate the first battery cell 611 and the third battery cell 613 from each other. However, unlike in the drawing, the blocking part 650 may extend to cover one surface of the first battery cell 611 that faces away from the third battery cell 613.

A side cell opening 642 may be provided on one side of the first battery cell 611 that is not covered by the blocking part 650. That is, the cell cover member 630 may include the side cell opening 642 such that one surface of the first battery cell 611 that faces toward the second battery cell 612 is open.

According to this structure, as illustrated in FIG. 19, a first cell cover member 631 may cover the first battery cell 611 and the third battery cell 613, and a second cell cover member 632 may cover the second battery cell 612 and a fourth battery cell 614.

Even though a fire occurs in the first battery cell 611 or the third battery cell 613 inside the first cell cover member 631, the cover part 670 of the first cell cover member 631 may be cut, and a high-pressure gas may be guided above the first cell cover member 631. The blocking part 650 of the second cell cover member 632 may delay heat transfer to the second battery cell 612. Accordingly, a thermal runaway phenomenon of the battery module 1 may be prevented.

Since the cell cover member 630 is provided in the shape of “L”, one side of the battery cells 611, 612, 613, and 614 in the second direction (the Y direction) may be open, and a cooling plate 625 for cooling the battery cells 611, 612, 613, and 614 may be additionally provided on the open one side. That is, the cooling plate 625 may be provided on a side of the battery cells 611, 612, 613, and 614 in the direction opposite to the second direction (the Y direction).

In addition, a support member 630h may be disposed below the cell cover member 630 and may be provided between the first battery cell 611 and the third battery cell 613. The support member 630h may be a surface pressure member for applying pressure to the first battery cell 611 and the third battery cell 613, or may be a fireproof sheet for thermally insulating the first battery cell 611 and the third battery cell 613 from each other. Alternatively, the support member 630h may be formed of silicone for simultaneously satisfying thermal insulation and the formation of surface pressure.

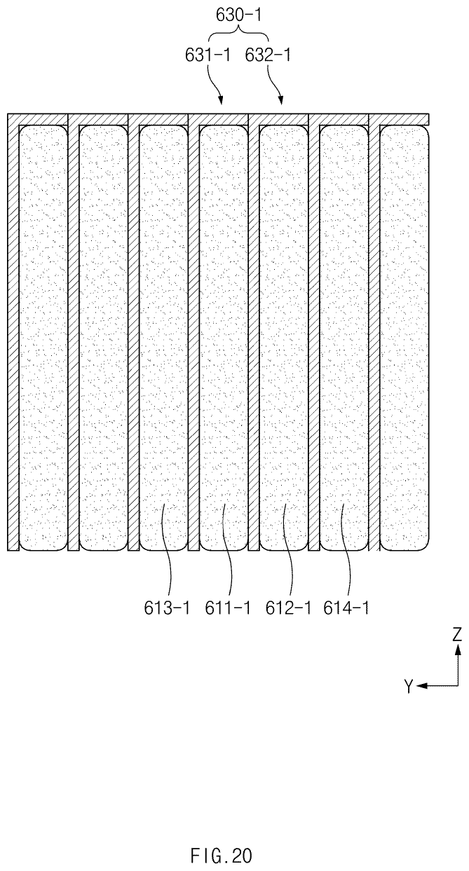

FIG. 20 is a side sectional view of a cell cover member according to another embodiment of the present disclosure.

Referring to FIG. 20, unlike the cell cover member 630 illustrated in FIG. 19, the cell cover member 630-1 may surround a single battery cell 611-1, 612-1, 613-1, or 614-1.

A first cell cover member 631-1 may cover one side of the first battery cell 611-1 in the vertical direction and one surface of the first battery cell 611-1 that faces toward the third battery cell 613-1. A second cell cover member 632-1 may cover the upper side of the second battery cell 612-1 and one surface of the second battery cell 612-1 that faces toward the fourth battery cell 614-1.

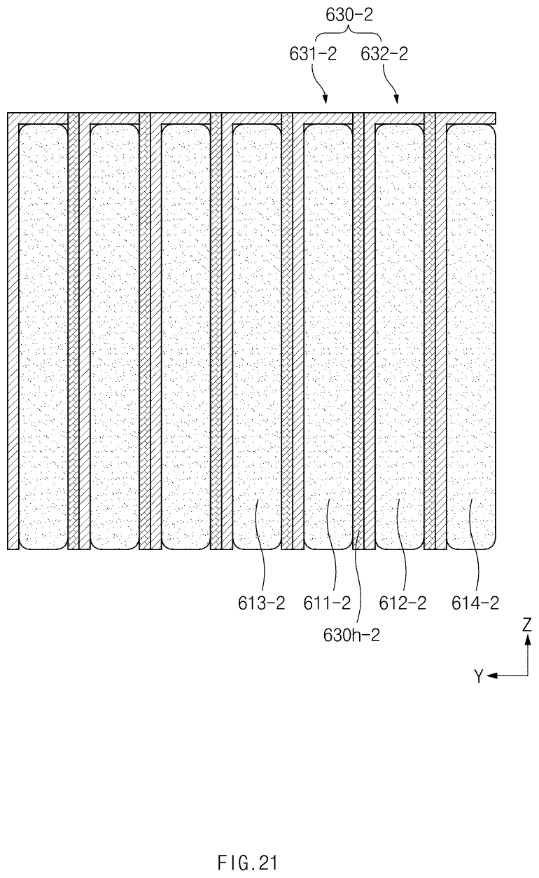

FIG. 21 is a side sectional view of some components of a battery module according to another embodiment of the present disclosure.

Referring to FIG. 21, a second battery cell 612-2 may be provided on one side of a first battery cell 611-2, and a third battery cell 613-2 may be provided on an opposite side of the first battery cell 611-2. A fourth battery cell 614-2 may be provided on the opposite side to the first battery cell 611-2 with respect to the second battery cell 612-2.

A cell cover member 630-2 may include a first cell cover member 631-2 that covers one side of the first battery cell 611-2 in the vertical direction and one surface of the first battery cell 611-2 that faces toward the third battery cell 613-2 and a second cell cover member 632-2 that covers the upper side of the second battery cell 612-2 and one surface of the second battery cell 612-2 that faces toward the first battery cell 611-2.

A support member 630h-2 may be provided between the first cell cover member 631-2 and the second cell cover member 632-2. According to this structure, heat transfer from the first battery cell 611-2 to the second battery cell 612-2 or the third battery cell 613-2 may be delayed. As described above, the support member 630h-2 may be implemented with a surface pressure member or a fireproof sheet. Alternatively, the support member 630h-2 may be formed of silicone for simultaneously satisfying thermal insulation and the formation of surface pressure.

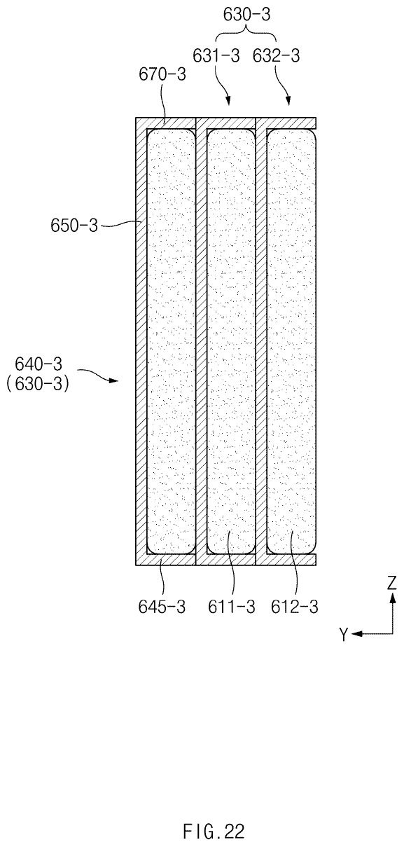

FIG. 22 is a side sectional view of a cell cover member according to another embodiment of the present disclosure.

Referring to FIG. 22, the cell cover member 630-3 may cover a single battery cell 611-3 or 612-3. When compared to the cell cover member 630-1 of FIG. 20, the cell cover member 630-3 of FIG. 22 may further include a base part 645-3 that covers an opposite side of the battery cell 611-3 or 612-3 in the vertical direction.

That is, the cell cover member 630-3 may include a cover part 670-3 that covers one side of the battery cell 611-3 or 612-3 in the vertical direction and that is cut by a high-pressure gas and a cover body 640-3 connected to the cover part 670-3. The cover body 640-3 may include a blocking part 650-3 extending to the opposite side in the vertical direction to separate the battery cell 611-3 or 612-3 and the base part 645-3 extending parallel to the cover part 670-3 from the blocking part 650-3.

A first cell cover member 631-3 and a second cell cover member 632-3 may have shapes corresponding to each other and may cover the battery cells 611-3 and 612-3, respectively.

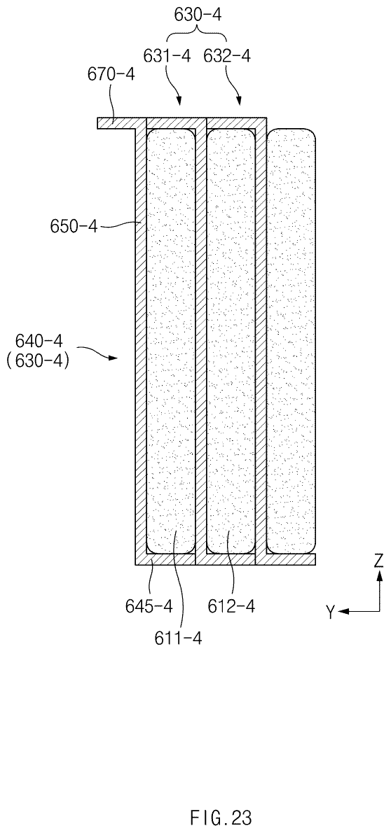

FIG. 23 is a side sectional view of a cell cover member according to another embodiment of the present disclosure.

Referring to FIG. 23, unlike the cell cover member 630-3 of FIG. 22, the cell cover member 630-4 may have a structure in which a cover part 670-4 extends from a blocking part 650-4 in the direction opposite to the direction in which a base part 645-4 horizontally extends.

That is, although a blocking part 650-4 of a first cell cover member 631-4 is disposed between a first battery cell 611-4 and a second battery cell 612-4 and a cover part 670-4 of the first cell cover member 631-4 extends to cover one side of the first battery cell 611-4 in the vertical direction, a base part 645-4 of the first cell cover member 631-4 may extend to cover an opposite side of the second battery cell 612-4 in the vertical direction. The structure of a second cell member 632-4 may correspond to the structure of the first cell cover member 631-4.

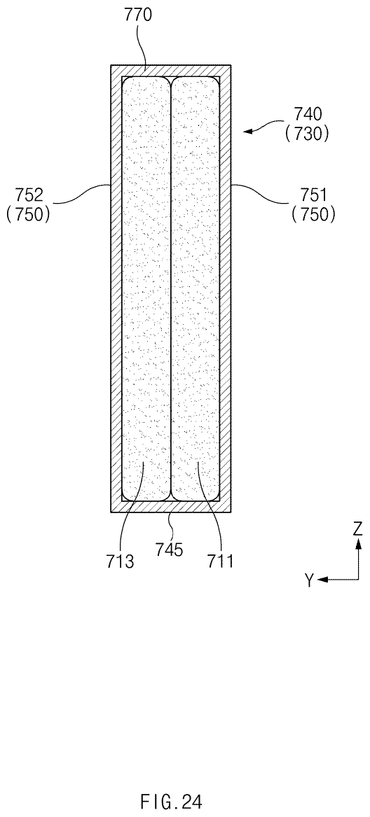

FIG. 24 is a side sectional view of a cell cover member according to another embodiment of the present disclosure.

Referring to FIG. 24, the cell cover member 730 may cover the outside of at least one battery cell 711 and 713. That is, the cell cover member 730 may cover the periphery of one battery cell 711 or 713, or may cover both the first battery cell 711 and the third battery cell 713 that is provided on an opposite side of the first battery cell 711 that faces away from one side of the first battery cell 711 on which a second battery cell is disposed.

A cover body 740 of the cell cover member 730 may include a first blocking part 751 that covers a side of the first battery cell 711 that faces in the direction opposite to the direction toward the third battery cell 713 and a second blocking part 752 that covers a side of the third battery cell 713 that faces in the direction opposite to the direction toward the first battery cell 711.

That is, the cell cover member 730 may include a blocking part 750 that covers the opposite sides of the first battery cell 711 and the third battery cell 713 in the horizontal direction.

The cell cover member 730 may include a cover part 770 that connects the first blocking part 751 and the second blocking part 752 and that is provided so as to be cut and a base part 745 that is provided parallel to the cover part 770 and that covers an opposite side of the first battery cell 711 and the third battery cell 713 in the vertical direction. The base part 745 may connect the first blocking part 751 and the second blocking part 752 and may cover the opposite side of the first battery cell 711 and the third battery cell 713 in the vertical direction.

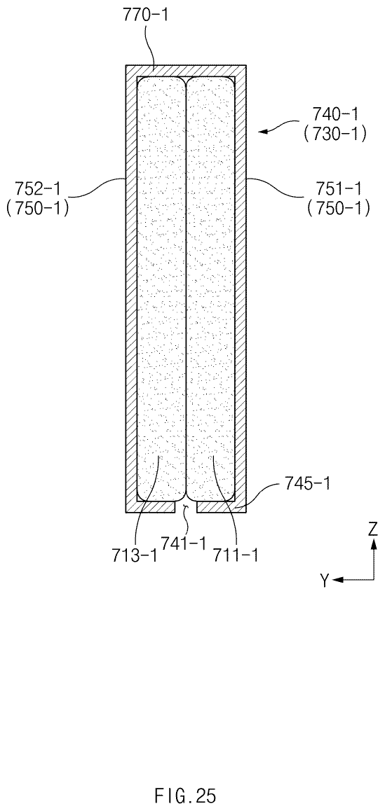

FIG. 25 is a side sectional view of a cell cover member according to another embodiment of the present disclosure.

Unlike the cell cover member 730 of FIG. 24, the cell cover member 730-1 of FIG. 25 has a structure in which a cell opening 741-1 is formed in a base part 745-1.

That is, the structure of a cover part 770-1 and a blocking part 750-1 that includes a first blocking part 751-1 that covers a side of a first battery cell 711-1 that faces in the direction opposite to the direction toward a third battery cell 713-1 and a second blocking part 752-1 that covers a side of the third battery cell 713-1 that faces in the direction opposite to the direction toward the first battery cell 711-1 may correspond to that illustrated in FIG. 24.

However, the cell opening 741-1 that is open toward an opposite side in the vertical direction may be formed in a portion of the base part 745-1 where the first battery cell 711-1 and the third battery cell 713-1 face each other, and thus a cooling effect may be improved.

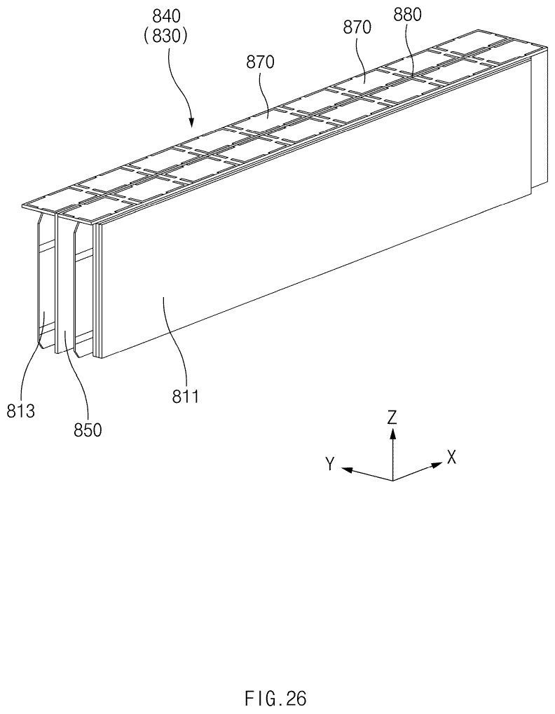

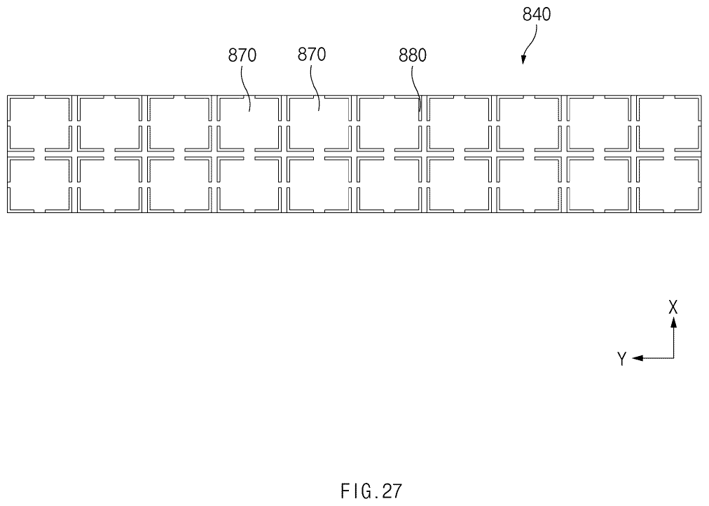

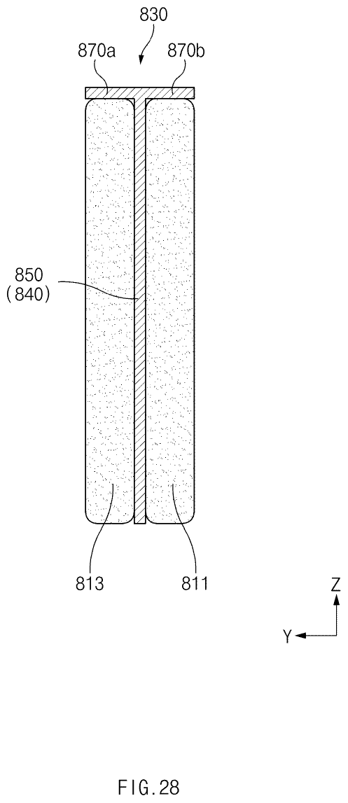

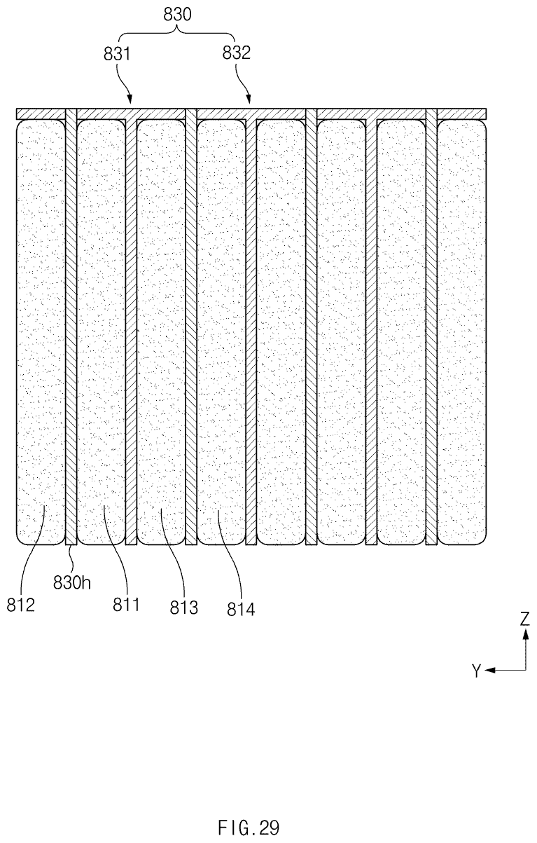

FIG. 26 is a perspective view of a cell cover member according to another embodiment of the present disclosure. FIG. 27 is a plan view of the cell cover member according to the other embodiment of the present disclosure illustrated in FIG. 26. FIG. 28 is a side sectional view of the cell cover member according to the other embodiment of the present disclosure illustrated in FIG. 26. FIG. 29 is a side sectional view of some components of a battery module according to another embodiment of the present disclosure.

Referring to FIGS. 26 to 29, the cell cover member 830 may be formed in the shape of “T”. The cell cover member 830 may include a blocking part 850 disposed between a first battery cell 811 and a third battery cell 813 and a cover part 870 extending from the blocking part 850 to cover one side of the first battery cell 811 or the third battery cell 813 in the vertical direction.

As described above, likewise to the cover part 70 illustrated in FIG. 3, the cover part 870 may be separated from a cover body 840 by a guide cutoff portion 880 extending along the periphery of the cover part 870.

The cover part 870 may include a first cover part 870a extending from the blocking part 850 in the second direction (the Y direction) to cover one side of the third battery cell 813 in the vertical direction and a second cover part 870b extending from the blocking part 850 in the direction opposite to the second direction (the Y direction) to cover one side of the first battery cell 811 in the vertical direction.

When a fire occurs in the third battery cell 813, the first cover part 870a may be separated from the cover body 840 and may form a first venting portion. When a fire occurs in the first battery cell 811, the second cover part 870b may be separated from the cover body 840 and may form a second venting portion.

As illustrated in FIG. 29, in a structure in which a plurality of cell cover members 830 are stacked, one side of the first battery cell 811 in the horizontal direction may be open, and a support member 830h may be provided between the first battery cell 811 and a second battery cell 812.

Similarly to the above-described support member 630h, the support member 830h may be a surface pressure member that applies pressure to the first battery cell 811 and the second battery cell 812, or may be a fireproof sheet for preventing heat transfer from the first battery cell 811 to the second battery cell 812. Alternatively, the support member 830h may be formed of silicone for simultaneously satisfying thermal insulation and the formation of surface pressure.

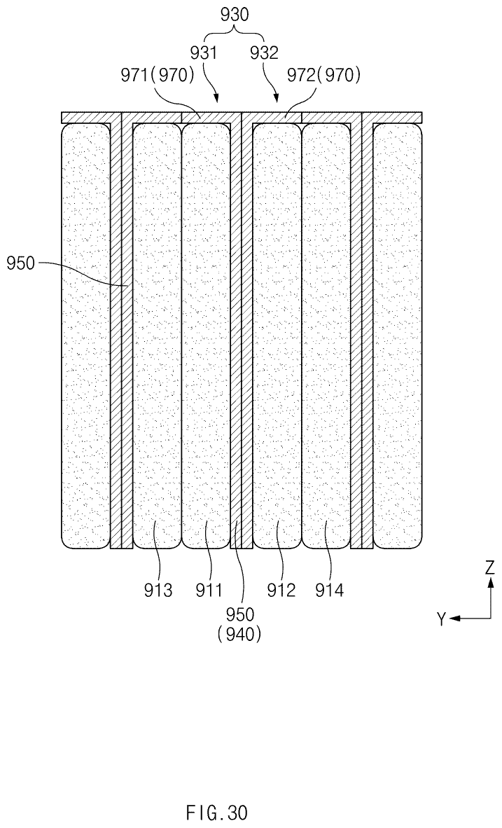

FIG. 30 is a side sectional view of some components of a battery module according to another embodiment of the present disclosure.

Referring to FIG. 30, a cell cover member 930 may cover a single battery cell 911, 912, 913, or 914. The cell cover member 930 may include a first cell cover member 931 and a second cell cover member 932 with which blocking parts 950 make contact, respectively.

The first cell cover member 931 may include a cover body 940 having a blocking part 950 that covers one surface of the first battery cell 911 that faces the second battery cell 912 and a first cover part 971 extending from the cover body 940 to cover one side of the first battery cell 911 in the vertical direction.

The second cell cover member 932 may include a cover body 940 having a blocking part 950 that covers one surface of the second battery cell 912 that faces the first battery cell 911 and a second cover part 972 extending from the cover body 940 in the direction opposite to the first cover part 971 to cover one side of the second battery cell 912 in the vertical direction.

As described above, the blocking parts 950 of the adjacent cell cover members 930 may make contact with each other, and the cover parts 971 and 972 may extend in the opposite directions.

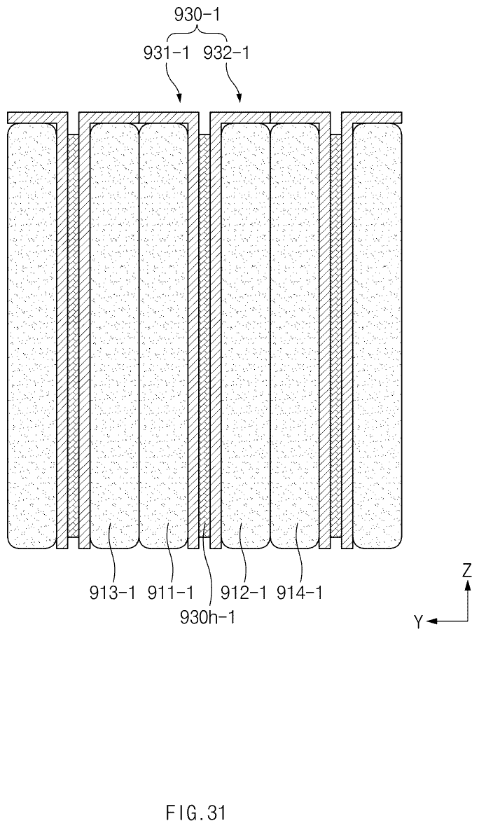

FIG. 31 is a side sectional view of some components of a battery module according to another embodiment of the present disclosure.

Referring to FIG. 31, in addition to the structure of FIG. 30, a support member 930h-1 may be provided between a first cell cover member 931-1 and a second cell cover member 932-1 of a cell cover member 930-1.

That is, the support member 930h-1 may be provided between a blocking part 950 of the first cell cover member 931-1 and a blocking part 950 of the second cell cover member 932-1. Accordingly, surface pressures between battery cells 911-1, 912-1, 913-1, and 914-1 may be improved, or thermal insulation therebetween may be improved.

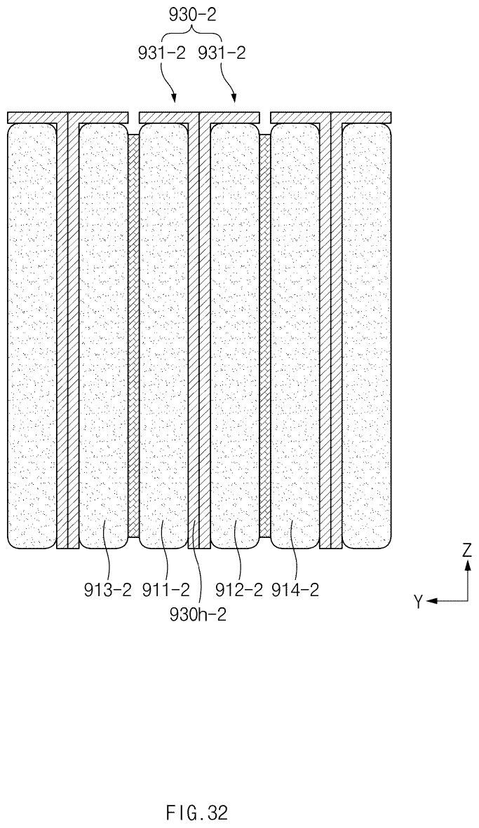

FIG. 32 is a side sectional view of some components of a battery module according to another embodiment of the present disclosure.

Referring to FIG. 32, unlike the support member 930h-1 of FIG. 31, a support member 930h-2 may prevent contact between adjacent battery cells 911-2, 912-2, 913-2, and 914-2.

In other words, the support member 930h-2 may be provided between the first battery cell 911-2 and the third battery cell 913-2 and may be provided between the second battery cell 912-2 and the fourth battery cell 914-2.

Even with this structure, the surface pressures between the battery cells 911-2, 912-2, 913-2, and 914-2 may be maintained, or heat transfer between the battery cells 911-2, 912-2, 913-2, and 914-2 may be delayed and a cooling effect may be improved.

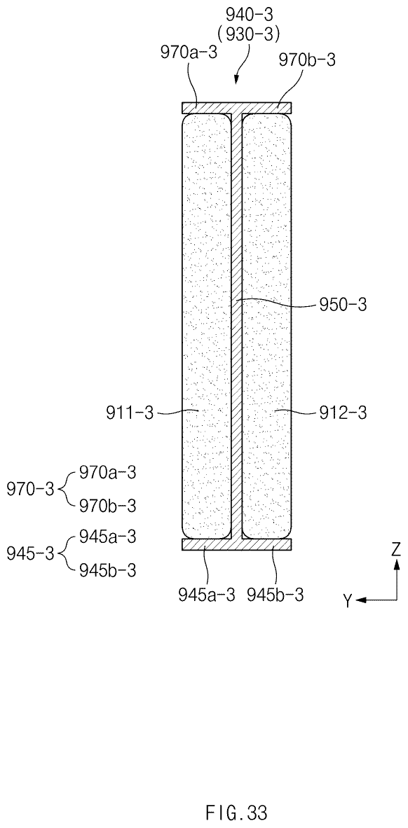

FIG. 33 is a side sectional view of a cell cover member according to another embodiment of the present disclosure.

Referring to FIG. 33, the cell cover member 930-3 may be formed in the shape of “I”. The cell cover member 930-3 may include a blocking part 950-3, a first cover part 970a-3, and a second cover part 970b-3. The blocking part 950-3 may separate a first battery cell 911-3 and a second battery cell 912-3 from each other, and the first cover part 970a-3 and the second cover part 970b-3 may extend in opposite directions from one end of the blocking part 950-3 that faces in the vertical direction.

In addition, the cell cover member 930-3 may include a first base part 945a-3 and a second base part 945b-3 that extend in opposite directions from an opposite end of the blocking part 950-3 that faces in the vertical direction.

As described above, the blocking part 950-3, the cover part 970-3, and the base part 945-3 may all be included in the cell cover member 930-3.

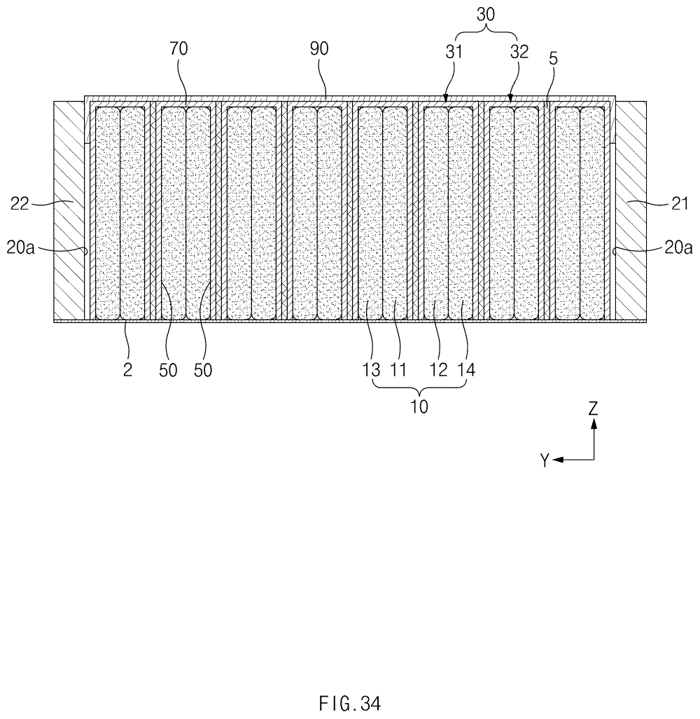

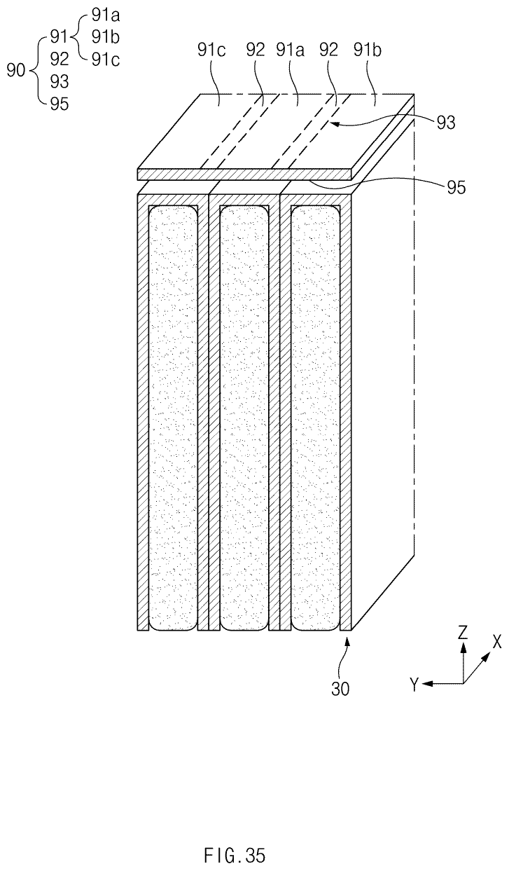

FIG. 34 is a side sectional view of some components of a battery module according to another embodiment of the present disclosure. FIG. 35 is a schematic view illustrating a fireproof cover member and a cell cover member of the battery module according to the other embodiment of the present disclosure.

Referring to FIGS. 34 and 35, unlike the battery module of FIG. 2, the battery module may further include the fireproof cover member 90 that is provided on one side of the cell cover member 30 in the vertical direction and that forms a guide portion discharging a fluid generated from a battery cell 10 from the one side of the cell cover member 30 in the vertical direction to a cell accommodating part 20a.

That is, in a structure in which a cover part 70 is disposed above the battery cell 10, the fireproof cover member 90 may be disposed above the cover part 70, and in a structure in which the cover part 70 is disposed below the battery cell 10, the fireproof cover member 90 may be disposed below the cover part 70. Hereinafter, the structure in which the cover part 70 is disposed above the battery cell 10 will be described. However, the cover part 70 and the fireproof cover member 90 may be disposed below the battery cell 10.

That is, the fireproof cover member 90 formed of a fireproof material may be provided above the cell cover member 30, and when a fire occurs in an adjacent battery cell 10 or an adjacent battery module, the fireproof cover member 90 may block a foreign substance transferred upward to prevent a flame from spreading to the internal battery cell 10. The cell cover member 30 and the fireproof cover member 90 may be stuck to each other such that the positions thereof are fixed.

However, when a fire occurs in the battery cell 10 supported by the cell cover member 30, a venting portion 60 may be formed while the cover part 70 of the cell cover member 30 is cut. In preparation for this case, the fireproof cover member 90 may be provided to form the guide portion 95.

That is, the guide portion 95 may be an opening that is disposed on the one side of the cell cover member 30 in the vertical direction and that discharges the fluid generated from the battery cell 10 from the one side of the cell cover member 30 in the vertical direction to the outside of the cell accommodating part 20a. When the battery cell 10 normally operates, a fireproof cover part 91 may be connected to a fireproof support part 92 to protect the battery cell 10 and the cell cover member 30, and when a fire occurs in the battery cell 10, the fireproof cover part 91, together with the cover part 70, may be cut off from the fireproof support part 92 along a fireproof guide cutoff portion 93 to form the guide portion 95.

As described above, the fireproof cover part 91 may be disposed on one side of the battery cell 10 in the vertical direction and may be cut by the pressure of the fluid generated from the battery cell 10, and the guide portion 95 may be formed as the fireproof cover part 91 is cut.

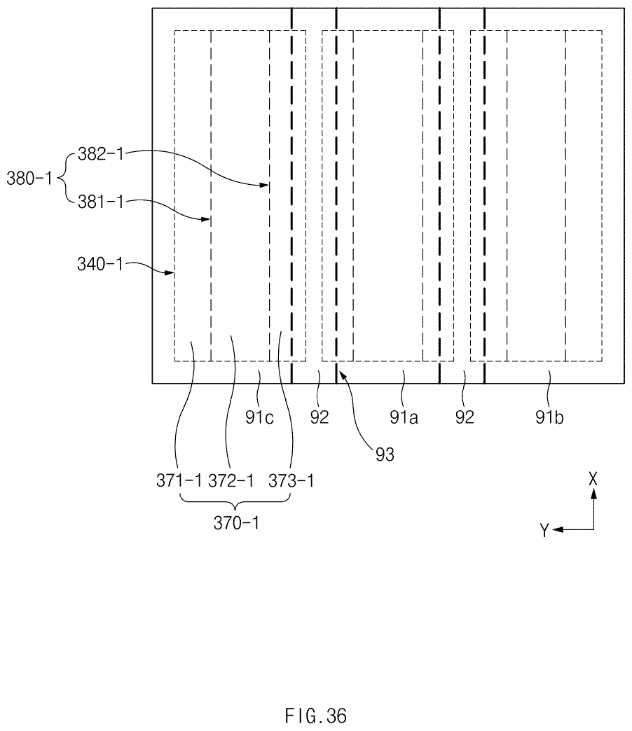

FIG. 36 is a schematic view illustrating the fireproof cover member and the cell cover member illustrated in FIG. 35.

As illustrated in FIG. 36, the fireproof cover part 91 may be connected with the fireproof support part 92 when the structure of FIG. 35 is viewed in the plan view. A structure of a guide cutoff portion 380-1 and a cover part 370-1 may be located on an opposite side of the fireproof cover part 91 in the vertical direction.

The guide cutoff portion 380-1 may include a first guide cutoff portion 381-1 and a second guide cutoff portion 382-1 that extend parallel to each other in the lengthwise direction of the cover part 370-1, and the cover part 370-1 may include first to third cover parts 371-1, 372-1, and 373-1 spaced apart from one another by the first guide cutoff portion 381-1 and the second guide cutoff portion 382-1.

As at least one of the first to third cover parts 371-1, 372-1, and 373-1 is cut, at least one of first to third fireproof cover parts 91a, 91b, and 91c may be cut, and the fireproof cover parts 91a, 91b, and 91c that are not cut and the fireproof support part 92 may remain connected.

For example, the second cover part 372-1 may be separated from the first cover part 371-1 and the third cover part 373-1 along the first guide cutoff portion 381-1 and the second guide cutoff portion 382-1 to form a venting portion, and the third fireproof cover part 91c may be cut off from the fireproof support part 92 to form a guide portion at the position. Accordingly, the venting portion and the guide portion may be connected with each other. According to this structure, a high-temperature and high-pressure gas may be more efficiently discharged to the outside of the cell accommodating part when a fire occurs in the battery cell.

However, the shape of the cover part of the cell cover member and the shape of the cover part of the fireproof cover member are not limited thereto.

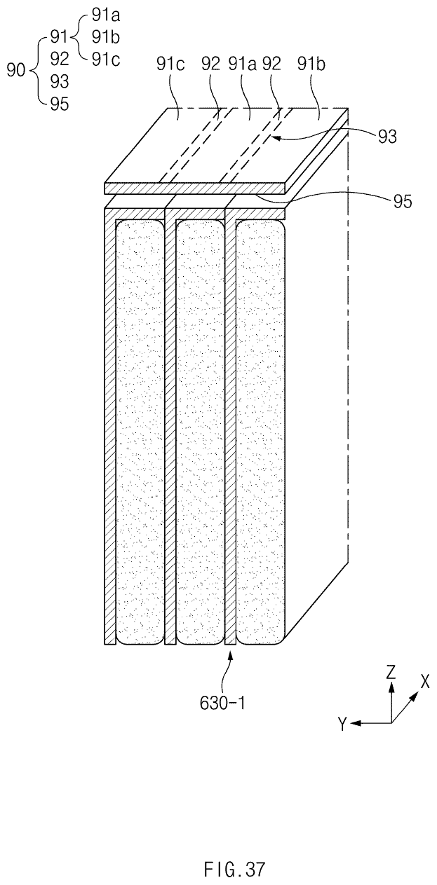

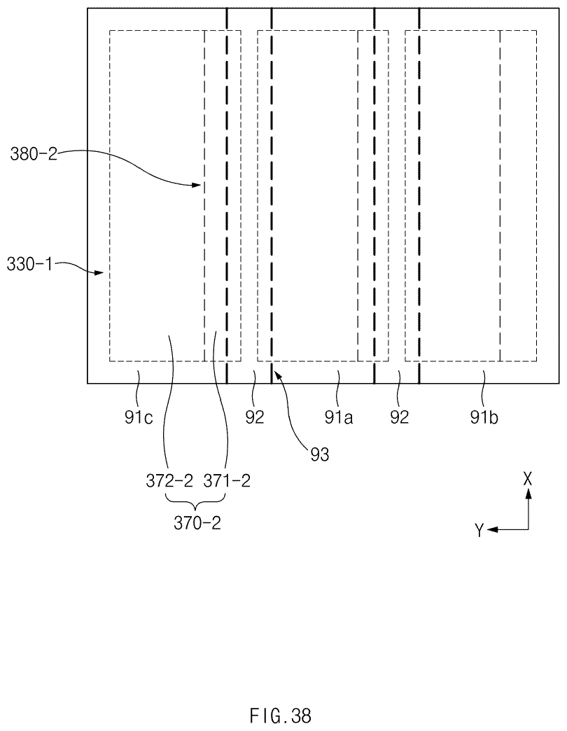

FIG. 37 is a schematic view illustrating a fireproof cover member and a cell cover member of a battery module according to another embodiment of the present disclosure. FIG. 38 is a schematic view illustrating the fireproof cover member and the cell cover member illustrated in FIG. 37.

Referring to FIGS. 37 and 38, the fireproof cover member 90 may be provided above the cell cover member 630-1.

In the structure of FIGS. 37 and 38, the structure of the fireproof cover member 90 may correspond to the above-described fireproof cover member 90, and the cell cover member 630-1 may be changed.

That is, a guide cutoff portion 380-2 may not be located at the center of a cover part 370-2 in the second direction (the Y direction) and may be biased to one side in the horizontal direction. The positions of cover parts 91a, 91b, and 91c of the fireproof cover member 90 may be provided to correspond to the guide cutoff portion 380-2.

For example, a first cover part 371-2 and a second cover part 372-2 may be separated along the guide cutoff portion 380-2 to form a venting portion, and the third fireproof cover part 91c may be cut off from a fireproof support part 92 to form a guide portion at the position. Accordingly, the venting portion and the guide portion may be connected with each other.

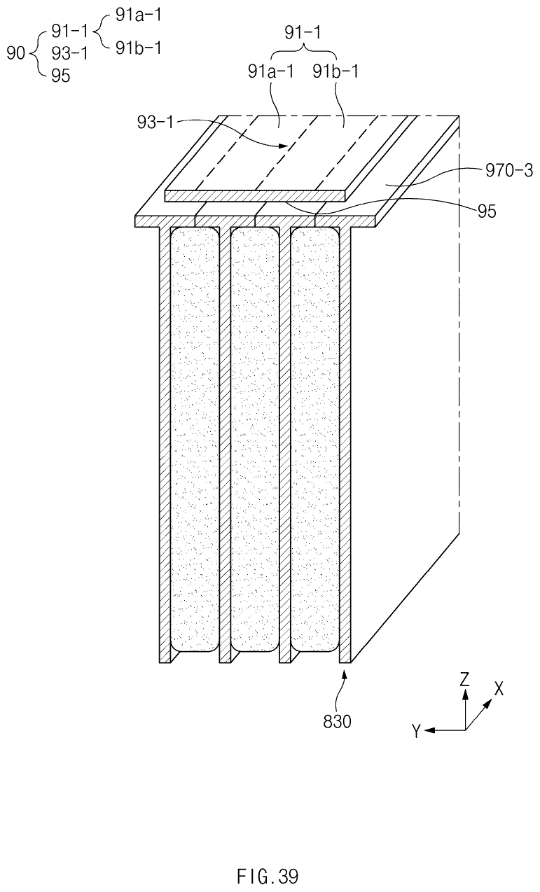

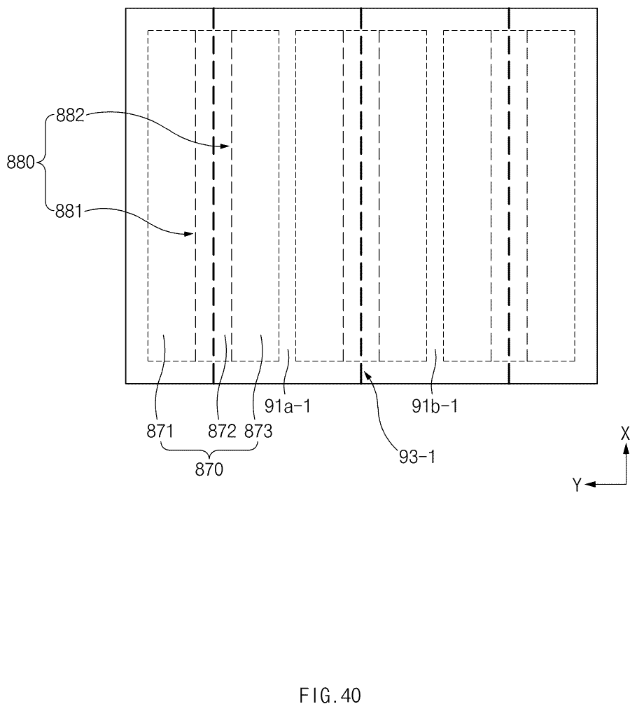

FIG. 39 is a schematic view illustrating a fireproof cover member and a cell cover member of a battery module according to another embodiment of the present disclosure. FIG. 40 is a schematic view illustrating the fireproof cover member and the cell cover member illustrated in FIG. 39.

Referring to FIGS. 39 and 40, unlike the fireproof cover member 90 illustrated in FIG. 37, the fireproof support part 92 may not exist. Accordingly, fireproof cover parts 91-1 may be connected by a guide cutoff portion 93-1.

In addition, the cell cover member 830 may include only a cover part 870 and a guide cutoff portion 880. The cover part 870 may include first to third cover parts 871, 872, and 873, and the guide cutoff portion 880 may include a first guide cutoff portion 881 provided between the first cover part 871 and the second cover part 872 and a second guide cutoff portion 882 provided between the second cover part 872 and the third cover part 873.

For example, when the third cover part 871 is cut off from the second cover part 872 along the second guide cutoff portion 882 to form a venting portion, a first fireproof cover part 91a-1 may be cut off from a second fireproof cover part 91b-1 along the fireproof guide cutoff portion 93-1 to form a guide portion. The venting portion and the guide portion may be connected with each other, and a high-pressure gas in the cell accommodating part 20a (refer to FIG. 34) may be discharged.

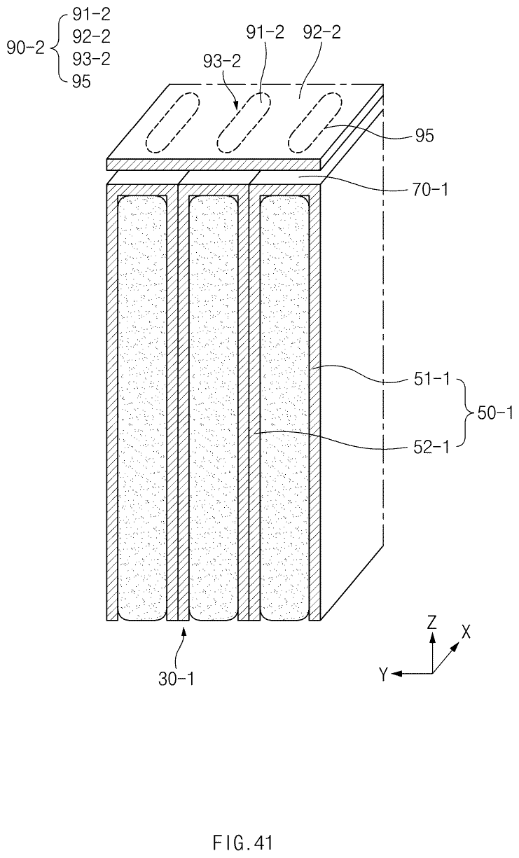

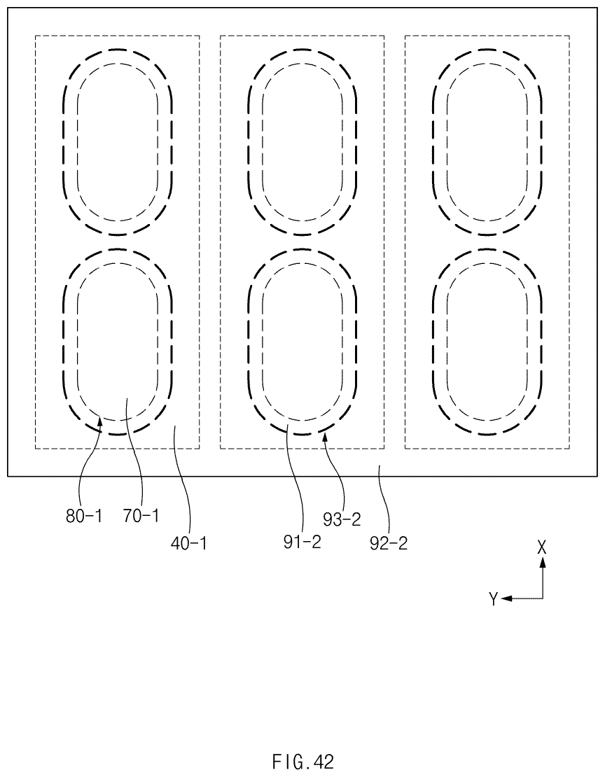

FIG. 41 is a schematic view illustrating a fireproof cover member and a cell cover member of a battery module according to another embodiment of the present disclosure. FIG. 42 is a schematic view illustrating the fireproof cover member and the cell cover member illustrated in FIG. 41.

Referring to FIGS. 41 and 42, a fireproof cover part 91-2 of the fireproof cover member 90-2 may have a shape connected to a fireproof support part 92-2 by a fireproof cover part 93-2 extending along the periphery of the fireproof cover part 91-2. Although the fireproof cover part 91-2 is illustrated in an oval shape, the fireproof cover part 91-2 is not limited thereto.

The shape of the cell cover member 30-1 is also not limited, and a cover part 70-1 may be connected from a cover body 40-1 by a guide cutoff portion 80-1 extending along the periphery of the cover part 70-1 of the cell cover member 30-1.

However, when the cover part 70-1 is cut along the guide cutoff portion 80-1 to form a venting portion, the fireproof cover part 91-2, which is larger in size than the cover part 70-1 so as to cover the cover part 70-1, may be separated from the fireproof support part 92-2 along the fireproof guide cutoff portion 93-2 to form a guide portion 95 connected with the venting portion.

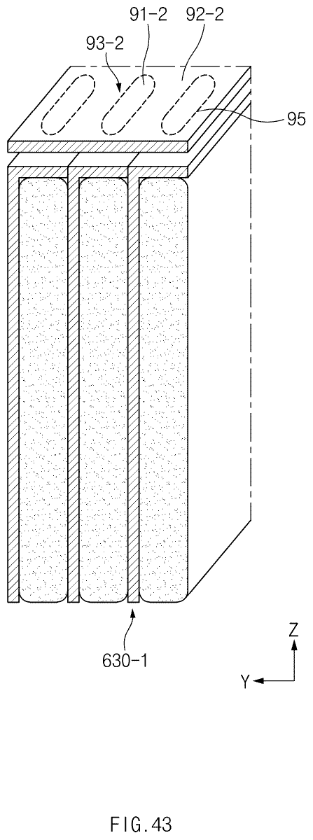

FIG. 43 is a schematic view illustrating a fireproof cover member and a cell cover member of a battery module according to another embodiment of the present disclosure.

Referring to FIG. 43, a structure of a fireproof cover part 91-2, a fireproof support part 92-2, and a fireproof guide cutoff portion 93-2 may correspond to that illustrated in FIG. 41, and only a structure of the cell cover member 630-1 may be changed.

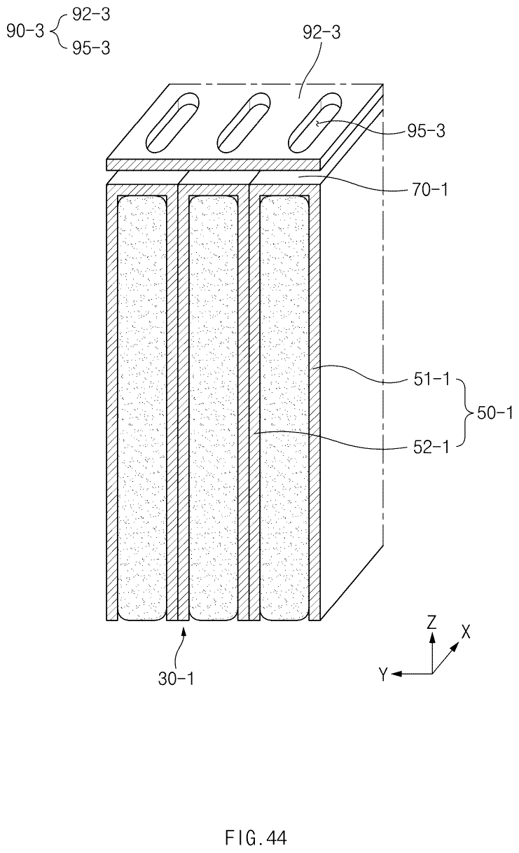

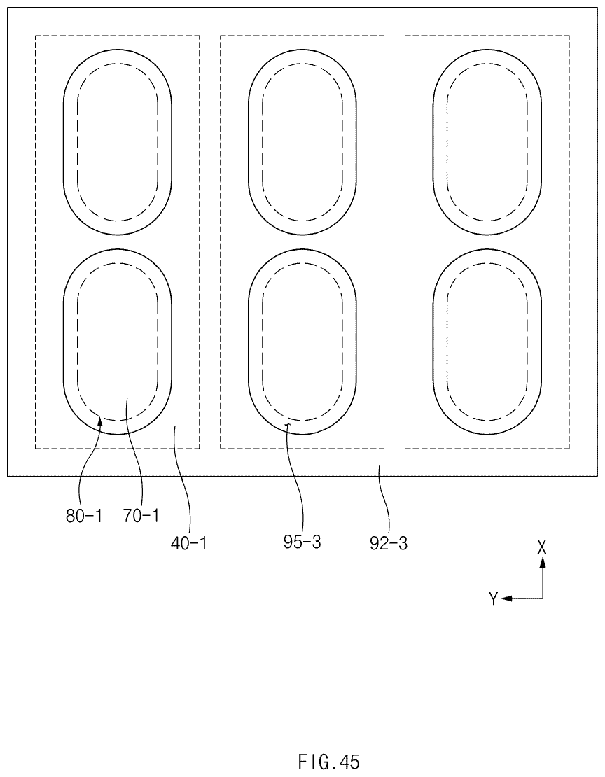

FIG. 44 is a schematic view illustrating a fireproof cover member and a cell cover member of a battery module according to another embodiment of the present disclosure. FIG. 45 is a schematic view illustrating the fireproof cover member and the cell cover member illustrated in FIG. 44.

Referring to FIGS. 44 and 45, unlike the above-described structure, the fireproof cover member 90-3 may include only a guide portion 95-3 without the fireproof cover parts 91, 91-1, and 91-2. That is, the guide portion 95-3 may be a hole formed in a fireproof cover part 90-3 rather than a structure formed by cutting the fireproof cover parts 91, 91-1, and 91-2 from the fireproof support parts 92 and 92-2.

Even in this case, when a cover part 70-1 is cut along a guide cutoff portion 80-1 to form a venting portion, the venting portion and the guide portion 95-3 may be connected with each other, and a fluid may be discharged to the outside. However, in this case, a separate fireproof member may be provided on one side of the fireproof cover member 90-3 in the vertical direction and may prevent heat transfer due to a high-temperature gas or a foreign substance caused by a fire occurring in an adjacent portion.

Meanwhile, unlike the cell cover members 30, 130, 230, 330, 430, 530, 630, 830, and 930, the fireproof cover members 90-3 illustrated in FIGS. 35 to 45 described above may be formed of a fireproof material rather than metal.

The thicknesses of the cell cover members 30, 130, 230, 330, 430, 530, 630, 830, and 930 in the vertical direction or the horizontal direction may be smaller than the thicknesses of the fireproof cover members 90-3 in the vertical direction or the horizontal direction. This is to sufficiently prevent heat transfer from outside the battery cell 10 (refer to FIG. 2) to the battery cell 10 by making the fireproof cover members 90-3 relatively thick. In addition, this is to provide higher energy density under the condition of the limited length of the battery cell 10 in the horizontal direction by making the cell cover members 30, 130, 230, 330, 430, 530, 630, 830, and 930 relatively thin.

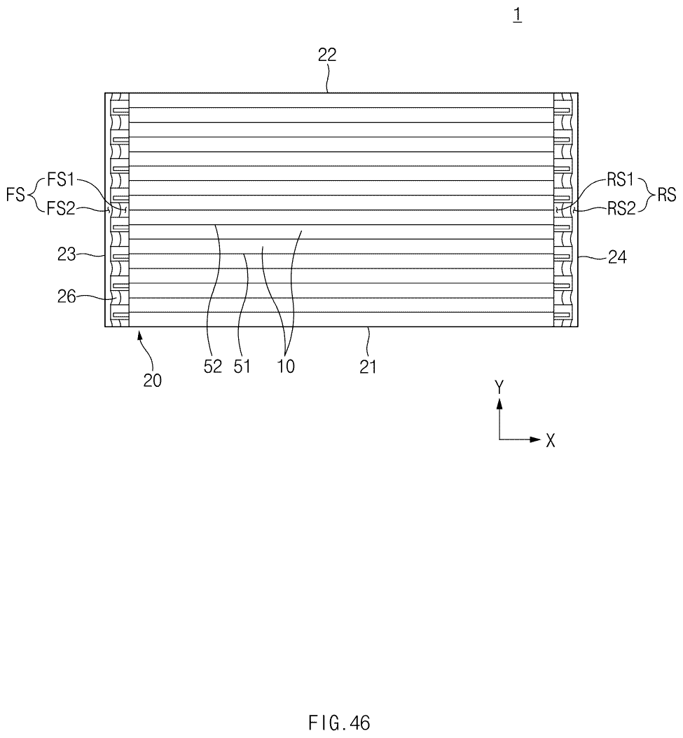

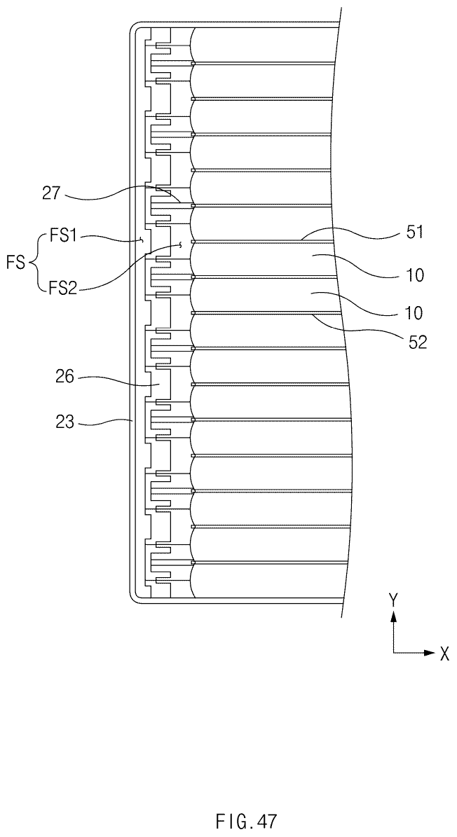

FIG. 46 is a schematic view of the battery module according to one embodiment of the present disclosure. FIG. 47 is a schematic view of a front end portion of the battery module illustrated in FIG. 46.

Referring to FIGS. 46 and 47, the third side frame 23 may be provided at the front end of the battery module 1, and the fourth side frame 24 may be provided at the rear end of the battery module 1. In addition, the second side frame 22 and the first side frame 21 may be provided on the opposite sides of the battery module 1 that face in the second direction (the Y direction) and the direction opposite to the second direction (the Y direction).

The first to fourth side frames 21, 22, 23, and 24 may form the module frame 20, and the plurality of battery cells 10 may be accommodated in the module frame 20. The module frame 20 may apply pressure to the plurality of battery cells 10.

The second blocking part 52 may be provided on one surface of the battery cell 10 that faces in the second direction (the Y direction), and the first blocking part 51 may be provided on one surface of the battery cell 10 that faces in the direction opposite to the second direction.

Meanwhile, the rear end portion of the battery module 1 may be provided on one side of the battery cell 10 that faces in the first direction (the X direction), and the front end portion of the battery module 1 may be provided on an opposite side of the battery cell 10 that faces in the direction opposite to the first direction (the X direction).

In more detail, a front space FS may be provided between the third side frame 23 and the battery cell 10, and a rear space RS may be provided between the fourth side frame 24 and the battery cell 10. Sensing boards 26 may be provided in the front space FS and the rear space RS, respectively.

The sensing boards 26 may be components for controlling the battery cell 10. The front space FS may be divided into a first front space FS1 and a second front space FS2 by the sensing board 26 in the front space FS. In addition, the rear space RS may also be divided into a first rear space RS1 and a second rear space RS2 by the sensing board 26 in the rear space RS.

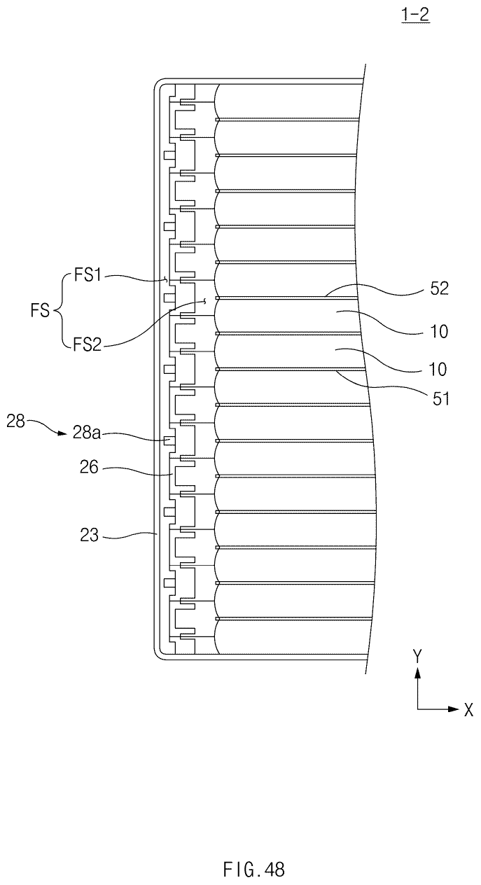

The sensing boards 26 may be connected to the battery cell 10 through sensing lines 27. When a fire occurs in the battery cell 10, heat transfer between the battery cell 10 and an adjacent battery cell 10 may be delayed by the first blocking part 51 and the second blocking part 52. However, it is apprehended that a foreign substance will be transferred to the adjacent battery cell 10 through the front space FS and the rear space RS. Hereinafter, partition walls 28 (refer to FIGS. 48 to 52) for solving the aforementioned problem will be described.

FIG. 48 is a schematic view of a front end portion of a battery module according to another embodiment of the present disclosure.

Referring to FIG. 48, a side partition wall 28 may be disposed between a sensing board 26 and a third side frame 23 of the battery module 1-2.

In more detail, a partition wall 28a of FIG. 48 may be connected to the sensing board 26 and may extend from the sensing board 26 toward the third side frame 23. The partition wall 28a may be provided in a first front space FS1 and may delay the transfer of a foreign substance or a high-pressure gas from a battery cell 10 in which a fire occurs to another battery cell 10 in the battery module 1-2 through the first front space FS1. Accordingly, safety may be improved.

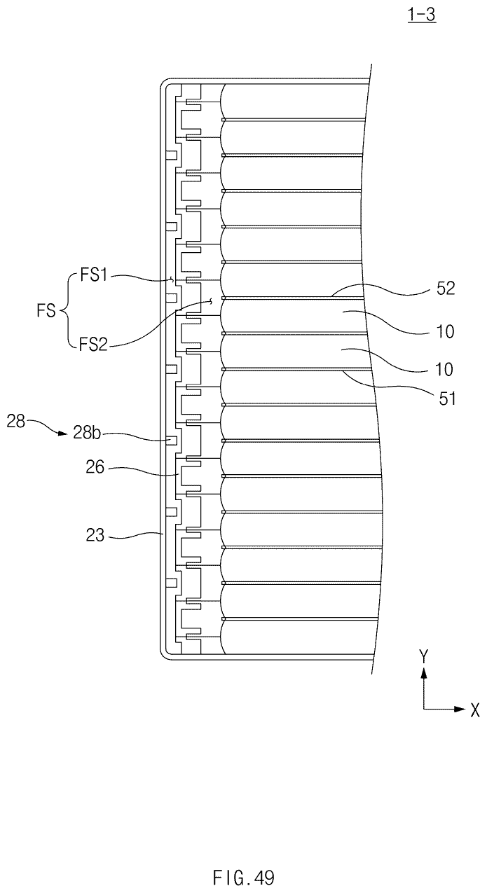

FIG. 49 is a schematic view of a front end portion of a battery module according to another embodiment of the present disclosure.

Referring to FIG. 49, a side partition wall 28 may be disposed between a sensing board 26 and a third side frame 23 of the battery module 1-3. A partition wall 28b of the battery module 1-3 may be provided in a first front space FS1. The partition wall 28b may be connected to the third side frame 23 and may extend from the third side frame 23 toward the sensing board 26.

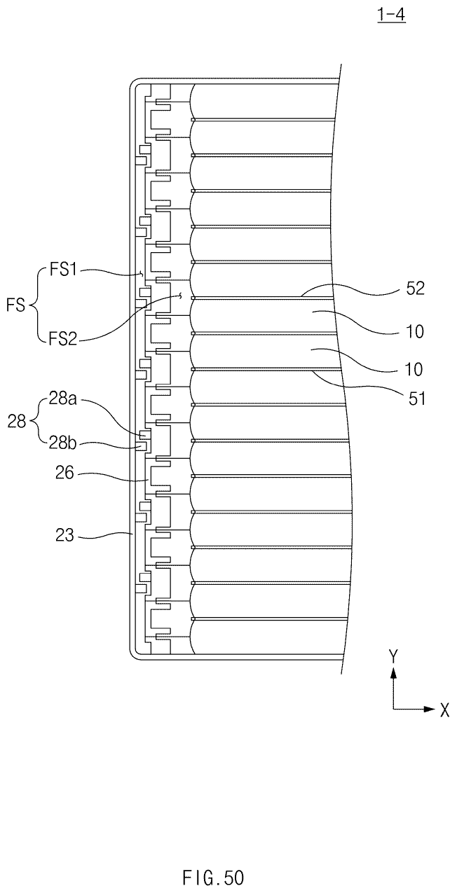

FIG. 50 is a schematic view of a front end portion of a battery module according to another embodiment of the present disclosure.

Referring to FIG. 50, a side partition wall 28 may be disposed between a sensing board 26 and a third side frame 23 of the battery module 1-4. The side partition wall 28 of the battery module 1-4 may include a first partition wall 28a extending from the sensing board 26 to the third side frame 23 and a second partition wall 28b extending from the third side frame 23 to the sensing board 26. The first partition wall 28a and the second partition wall 28b may be alternately arranged in the second direction (the Y direction).

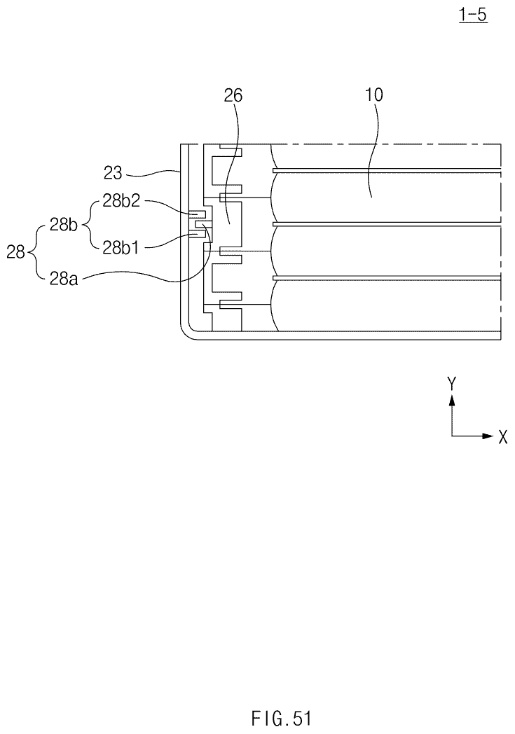

FIG. 51 is a schematic view of a front end portion of a battery module according to another embodiment of the present disclosure.

Referring to FIG. 51, a side partition wall 28 of the battery module 1-5 may include a first partition wall 28a extending from a sensing board 26 to a third side frame 23 and a second partition wall 28b extending from the third side frame 23 to the sensing board 26.

The second partition wall 28b may include a second-first partition wall 28b1 and a second-second partition wall 28b2 disposed to face each other with the first partition wall 28a therebetween. As described above, the side partition wall 28 of the battery module 1-5 may include the second-first partition wall 28b1, the first partition wall 28a, and the second-second partition wall 28b2 alternately arranged in the second direction (the Y direction).

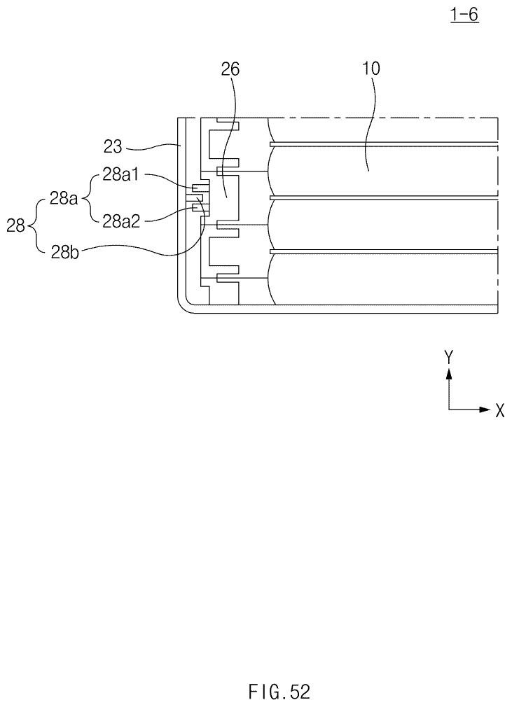

FIG. 52 is a schematic view of a front end portion of a battery module according to another embodiment of the present disclosure.

Referring to FIG. 52, a side partition wall 28 of the battery module 1-6 may include a first partition wall 28a extending from a sensing board 26 toward a third side frame 23 and a second partition wall 28b extending from the third side frame 23 toward the sensing board 26.

The first partition wall 28a may include a first-first partition wall 28al and a first-second partition wall 28a2 disposed to face each other with the second partition wall 28b therebetween. As described above, the side partition wall 28 of the battery module 1-6 may include the first-first partition wall 28al, the second partition wall 28b, and the first-second partition wall 28a2 alternately arranged in the second direction (the Y direction).

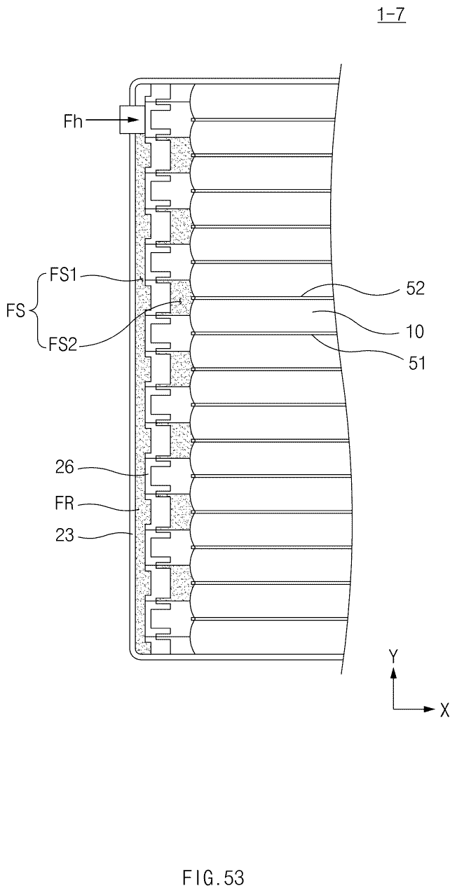

FIG. 53 is a schematic view of a front end portion of a battery module according to another embodiment of the present disclosure.

Referring to FIG. 53, the battery module 1-7 may include a fireproof material FR provided between a third side frame 23 and a battery cell 10. The fireproof material FR may be injected into a front space FS of the battery module 1-7. The third side frame 23 may have a fireproof material injection hole Fh formed therein through which the fireproof material FR is injected into a first front space FS1 and a second front space FS2.

After the fireproof material FR is injected through the injection hole Fh, the injection hole Fh may be closed. Since the fireproof material FR is injected into the front space FS, even though a fire occurs in the battery cell 10, heat transfer to an adjacent battery cell 10 may be delayed by blocking parts 51 and 52, and the transfer of a flame through the front space FS may be delayed by the fireproof material FR. Due to this, the safety of the battery module 1-7 may be improved.

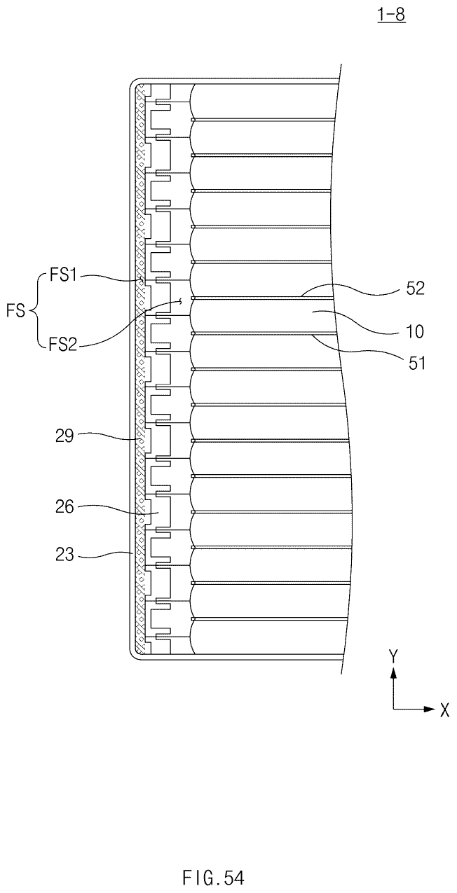

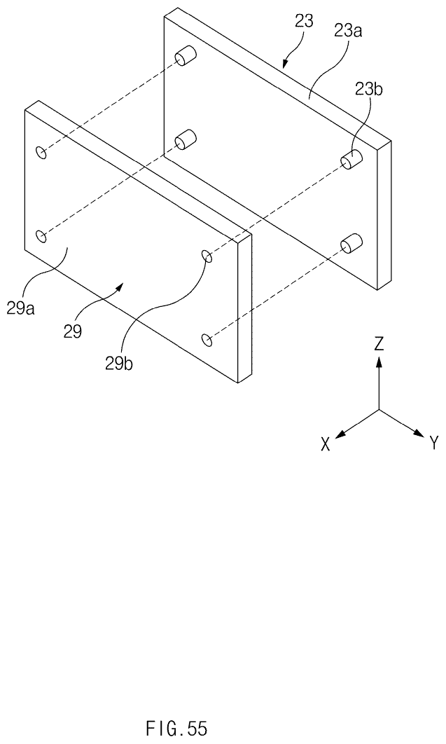

FIG. 54 is a schematic view of a front end portion of a battery module according to another embodiment of the present disclosure. FIG. 55 is a schematic view illustrating a coupling structure of a fireproof pad and a third side frame illustrated in FIG. 54.

Referring to FIGS. 54 and 55, the battery module 1-8 may include the fireproof pad 29 provided between the third side frame 23 and a battery cell 10.

In more detail, the fireproof pad 29 may be attached to an inner surface of the third side frame 23 that faces toward the battery cell 10 and may be accommodated in a first front space FS1.

Due to the fireproof pad 29, the transfer of a fire through a front space FS of the battery cell 10 may be delayed.

Meanwhile, the third side frame 23 may include a side frame body 23a and an insertion protrusion 23b protruding from the side frame body 23a toward the battery cell 10 in the first direction (the X direction).

The fireproof pad 29 may include an insertion hole 29b that is formed in a pad body 29a and into which the insertion protrusion 23b is inserted. As the insertion protrusion 23b is inserted into the insertion hole 29b, the fireproof pad 29 may be coupled to the third side frame 23, and the position of the fireproof pad 29 may be fixed.

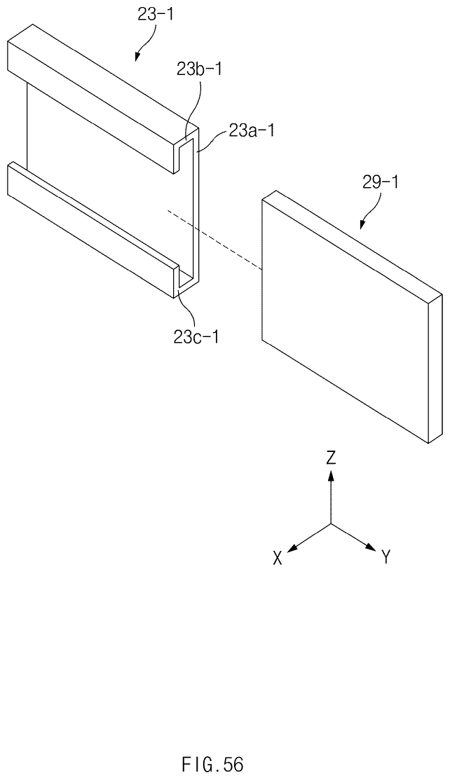

FIG. 56 is a schematic view illustrating another coupling structure of the fireproof pad and the third side frame illustrated in FIG. 54.

Referring to FIG. 56, a fireproof pad 29-1 may be coupled with a third side frame 23-1 in a structure in which the fireproof pad 29-1 is inserted into the third side frame 23-1. The third side frame 23-1 may include a side frame body 23a-1, a first locking part 23b-1, and a second locking part 23c-1. The first locking part 23b-1 and the second locking part 23c-1 may protrude in the first direction (the X direction) toward the battery cell 10 (refer to FIG. 54) of the side frame body 23a-1 and may protrude toward each other in the vertical direction.

The first locking part 23b-1 and the second locking part 23c-1 may protrude from upper and lower ends of the side frame body 23a-1 toward the battery cell 10 and may be bent toward each other. The fireproof pad 29-1 may be inserted through one side of the first locking part 23b-1 and one side of the second locking part 23c-1. The first locking part 23b-1 and the second locking part 23c-1 may apply pressure to the fireproof pad 29-1 in the direction opposite to the first direction (the X direction), and thus the position of the fireproof pad 29-1 may be fixed.

Meanwhile, as described above, the structures in the front spaces FS described above may be correspondingly formed in the rear spaces RS of the battery modules 1, 1-2, 1-3, 1-4, 1-5, 1-6, 1-7, and 1-8.

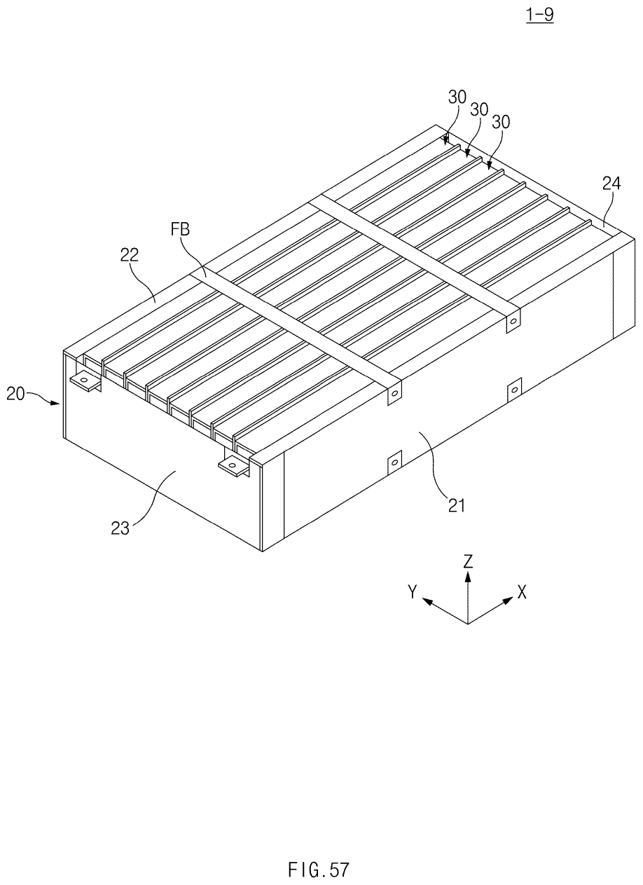

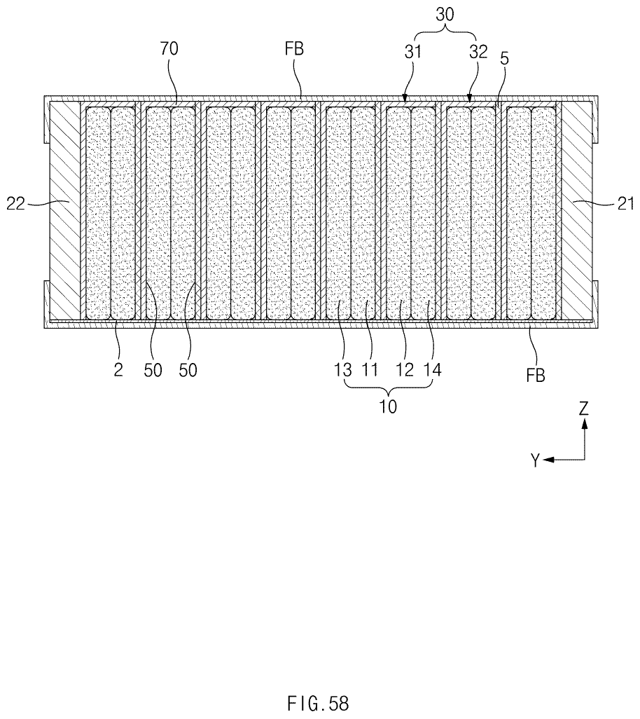

FIG. 57 is a perspective view of a battery module according to another embodiment of the present disclosure. FIG. 58 is a side sectional view of the battery module illustrated in FIG. 57.

Referring to FIGS. 57 and 58, unlike the battery module 1 illustrated in FIG. 1, the battery module 1-9 may further include a clamp part FB. The clamp part FB may be implemented with a fixing band. The clamp part FB may be provided such that a first side frame 21 and a second side frame 22 of the battery module 1-9 are forced in directions toward each other.

According to this structure, the clamp part FB may be provided on the upper side of a cell cover member 30 and the lower side of a base plate 2. The clamp part FB may prevent a plurality of battery cells 10 stacked in the second direction (the Y direction) from moving away from one another without a separate upper cover of the battery module. That is, even though the battery cells 10 are swelled, the battery cells 10 may be forced by the clamp part FB, and thus the performance of the battery cells 10 may be prevented from being deteriorated.

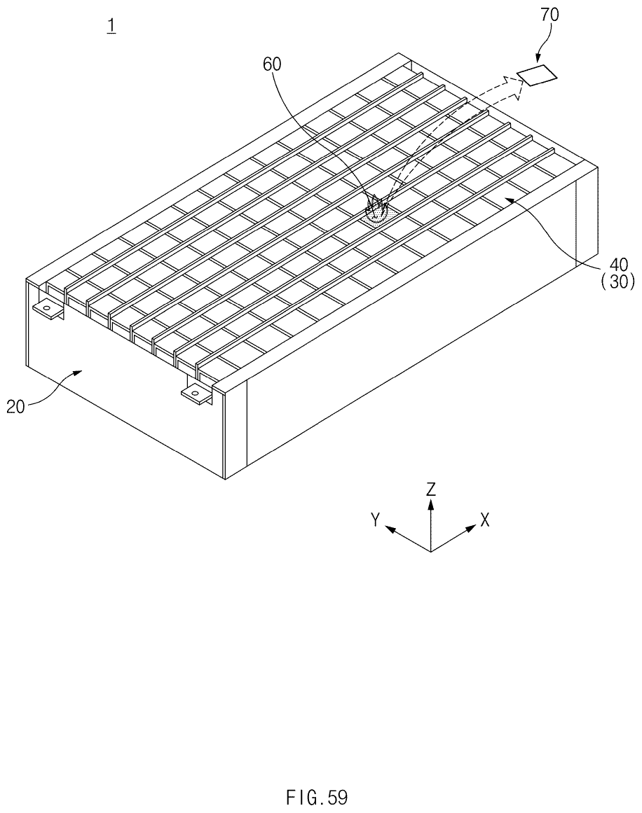

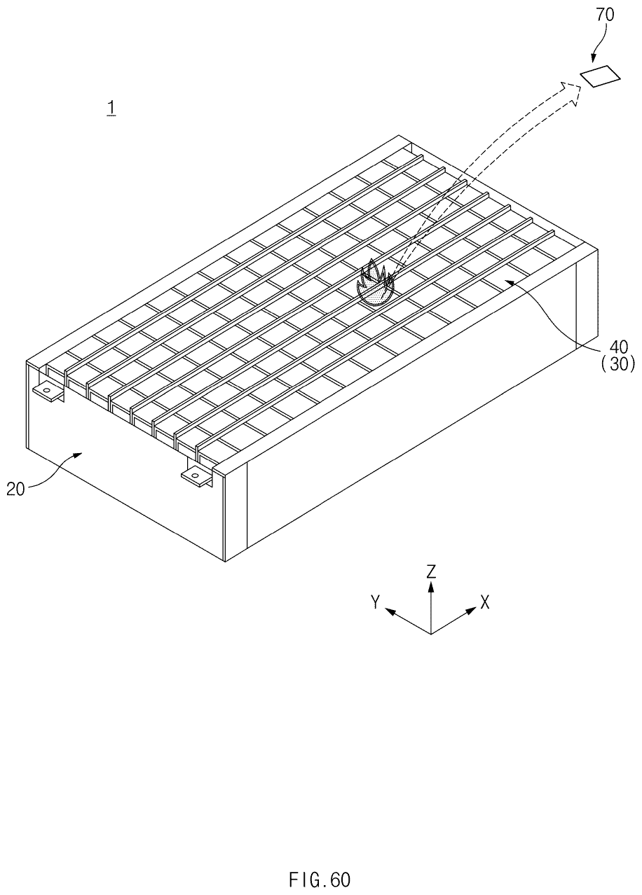

FIGS. 59 and 60 are schematic views illustrating a state in which the cover part 70 is separated from the cover body 40 due to a fire occurring in the first battery cell of the battery module 1 according to one embodiment of the present disclosure and heat transfer from the first battery cell to the second battery cell adjacent thereto is prevented.

Referring to FIGS. 2, 59, and 60, before the fire occurs in the first battery cell 11, the cover part 70 may be connected to the cover body 40 and may cover one side of the first battery cell 11 in the vertical direction.

When the fire occurs in the first battery cell 11, the guide connecting portions 81b, 82b, 83, and 84b may be cut by the pressure of a high-pressure gas or a flame, and thus the cover part 70 may be separated from the battery module 1 while being separated from the cover body 40.

As the cover part 70 is separated from the cover body 40, a fluid generated from the first battery cell 11 may be guided to one side of the first battery cell 11 in the vertical direction by the pressure. According to this structure, the fluid generated from the first battery cell 11 may be prevented from flowing to the adjacent second battery cell 12.

In addition, due to the blocking part 50 of the cell cover member 30, heat transfer from the first battery cell 11 at a relatively high temperature to the second battery cell 12 may be prevented.

Due to this, the battery module 1 may prevent a thermal runaway phenomenon occurring while heat is transferred between the adjacent battery cells 10, and thus a user's safety accident may be prevented. In addition, by applying pressure to the battery cells 10, the efficiency of the battery cells 10 may be simultaneously prevented from being lowered.

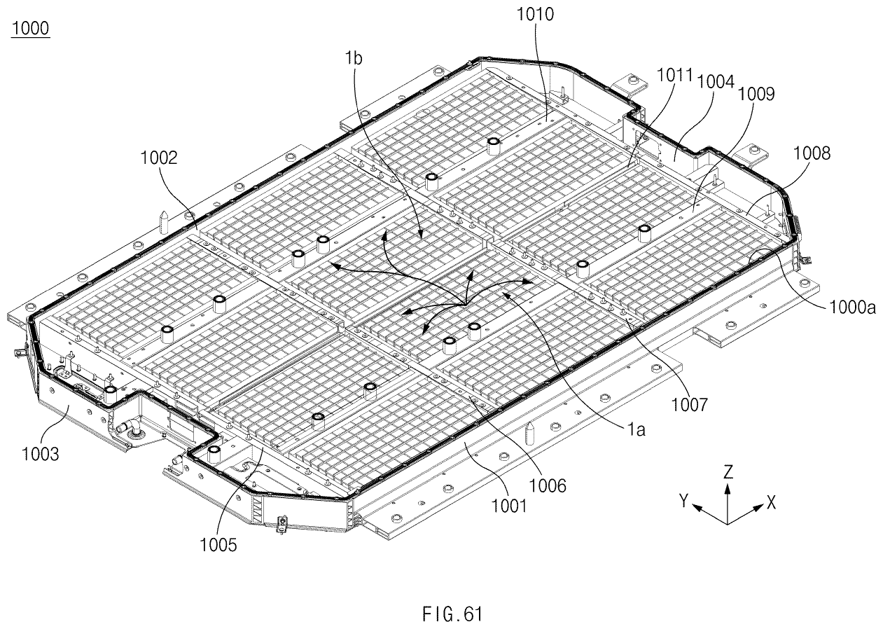

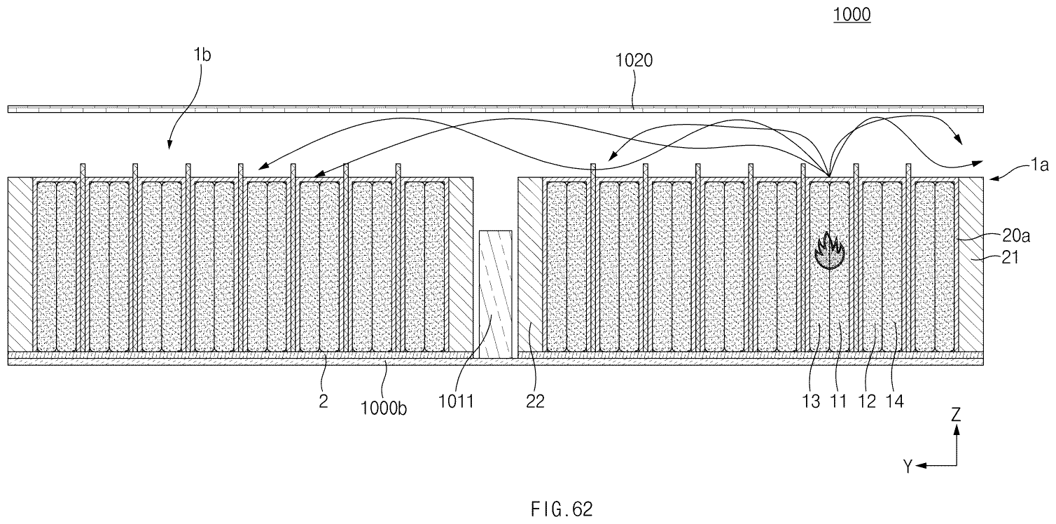

FIG. 61 is a schematic view of a battery pack system 1000 that prevents a flame occurring in a first battery module 1a from being introduced into a second battery module 1b according to one embodiment of the present disclosure. FIG. 62 is a side sectional view of the battery pack system that prevents the flame occurring in the first battery module from being introduced into the second battery module according to one embodiment of the present disclosure.

Referring to FIGS. 61 and 62, the battery pack system 1000 may include a left outer wall 1001, a right outer wall 1002, a front outer wall 1003, and a rear outer wall 1004 provided to accommodate the plurality of battery modules 1a and 1b. The battery pack system 1000 may include a base wall 1000b to support the battery modules 1a and 1b.

A module accommodating part 1000a may be formed between the left outer wall 1001, the right outer wall 1002, the front outer wall 1003, and the rear outer wall 1004, and the plurality of battery modules 1a and 1b may be accommodated in the module accommodating part 1000a.

In addition, the plurality of battery modules 1a and 1b may be spaced apart from each other in the first direction (the X direction) by a front transverse member 1005, a rear transverse member 1008, a first transverse member 1006, and a second transverse member 1007.

Likewise, the plurality of battery modules 1a and 1b may be spaced apart from each other by a first longitudinal member 1009, a second longitudinal member 1010, and a third longitudinal member 1011.

The battery pack system 1000 may include a battery pack cover 1020 that covers the upper sides of the battery modules 1a and 1b. When a fire occurs in the first battery module 1a, the battery pack cover 1020 may prevent foreign substances moving above the first battery module 1a from escaping from the battery pack system 1000, and thus safety may be improved.

In addition, a thermal runaway phenomenon of the battery modules 1a and 1b may be prevented by cell cover members 30 at the same time that a foreign substance or a high-pressure gas caused by a flame is prevented from being introduced into the second battery module 1b from the first battery module 1a in which the fire occurs. Accordingly, the thermal runaway phenomenon may be more efficiently prevented. Due to this, even though the fire occurs in the first battery module 1a, thermal runaway may be prevented from occurring in the battery pack system 1000. Thus, a user's safety accident may be prevented, and the durability of the other battery module 1b may be improved.

However, without being limited to that illustrated in the drawings, in the above-described battery modules 1a and 1b, the cover part 70 (refer to FIG. 2) may be disposed to face toward the base wall 1000b, and the base plate 2 may be disposed to face toward the battery pack cover 1020. In this case, the battery modules 1a and 1b may be coupled to and supported on the base wall 1000b by the module frame 21, 22, 23, and 24.

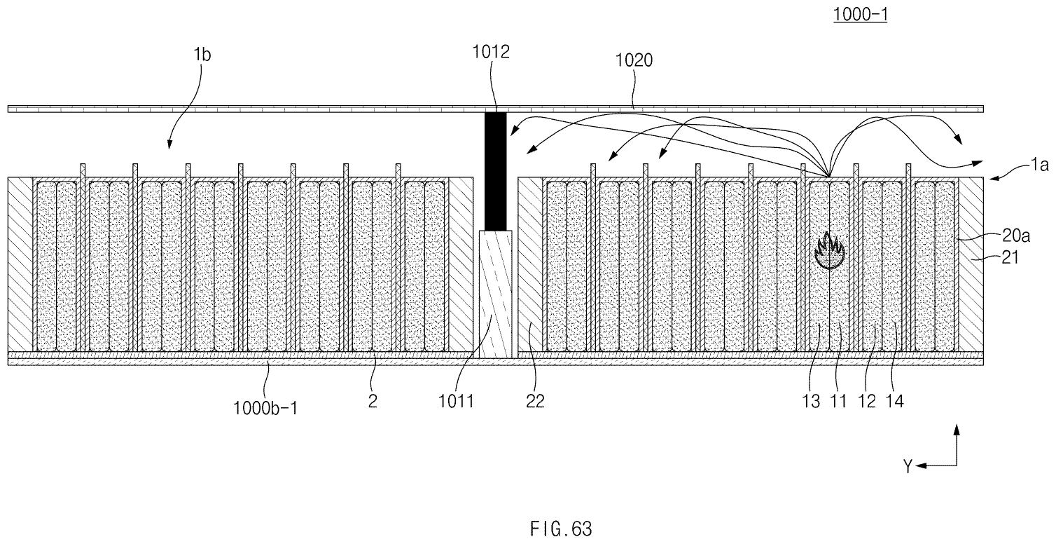

FIG. 63 is a side sectional view of a battery pack system that prevents a flame occurring in a first battery module from being introduced into a second battery module according to another embodiment of the present disclosure.

Referring to FIG. 63, unlike the battery pack system 1000 of FIG. 62, the battery pack system 1000-1 may further include a middle member 1012 disposed between a third longitudinal member 1011 provided on a base wall 1000b-1 and a battery pack cover 1020.

Due to this structure, when a fire occurs in the first battery module 1a, heat transfer from a first battery cell 11 to a second battery cell 12 adjacent thereto may be delayed, and due to the battery pack cover 1020, a high-pressure gas vented upward may not be discharged to the outside of the battery pack system 1000-1.

In addition, a foreign substance or a high-pressure gas that is moved upward from the first battery module 1a and that collides with the battery pack cover 1020 may be prevented from moving to the second battery module 1b. Accordingly, the transfer of the fire to the second battery module 1b may be delayed, and thus safety may be improved.

Even in this case, in the battery modules 1a and 1b, the cover part 70 (refer to FIG. 2) may be disposed to face toward the base wall 1000b-1, and the base plate 2 may be disposed to face toward the battery pack cover 1020.

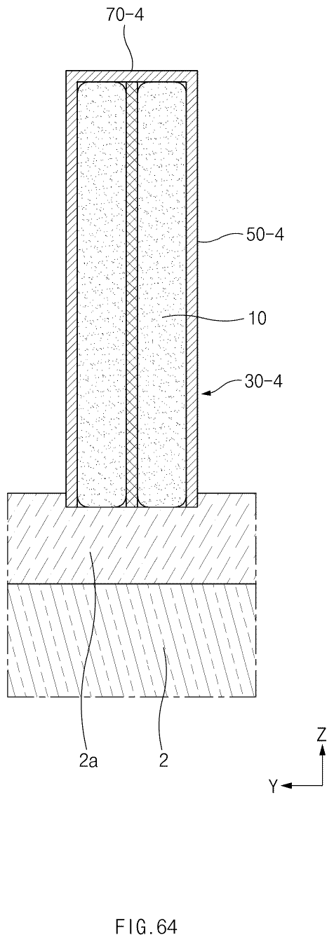

FIG. 64 is a side sectional view of a cell cover member inserted into a gap filler according to one embodiment of the present disclosure.

Referring to FIG. 64, the cell cover member 30-4 may be formed of metal having relatively strong fire resistance. The structure of the cell cover member 30-4 is not limited, and the cell cover member 30-4 may be formed of metal in the shape of the cell cover member appended in this specification. However, when the cell cover member 30-4 is formed of metal, the shape of a cover part may be relative small.

When the cell cover member 30-4 is formed of metal, a cooling effect of a battery cell 10 may be improved. In addition, a coolant channel (not illustrated) may be provided in a base plate 2. In this case, the gap filler 2a may be provided between the base plate 2 and the battery cell 10, and the cell cover member 30-4 may be connected to the gap filler 2a. Accordingly, the cooling effect of the battery cell 10 may be further improved.

FIG. 65 is a side sectional view of a cell cover member inserted into a gap filler according to another embodiment of the present disclosure.

Referring to FIG. 65, a base part 45-4 of the cell cover member 30-4 may be provided in a bent shape such that the length by which the block part 50-4 is inserted into the gap filler 2a is relatively long. Accordingly, a contact area between the cell cover member 30-4 and the gap filler 2a may be increased, and thus a cooling effect of a battery cell 10 may be improved.

However, the structure of the cell cover member 30-4 is not limited thereto.

According to the present disclosure, the high-temperature gas caused by the fire occurring in the battery cell may be vented to the outside of the battery module. Accordingly, the heat transfer to the adjacent battery cell may be prevented, and thus a thermal runaway phenomenon in the battery module may be prevented.

Further, the cell cover member may be cut only when the fire occurs in the battery cell. Accordingly, the gas in the battery module may be more stably guided to the outside of the battery module.

Furthermore, the heat transfer to the adjacent battery cell due to the fire occurring in the battery cell may be prevented. Accordingly, safety accidents may be prevented.

Moreover, the cell cover member may separate and support the first battery cell and the second battery cell. Accordingly, the cell cover member may be pressed while preventing the heat transfer between the battery cells, and thus the efficiency of the battery cells may be increased.

In addition, the present disclosure may provide various effects that are directly or indirectly recognized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A battery module comprising:
a battery cell including a first battery cell and a second battery cell distinguished from the first battery cell;
a module frame configured to form a cell accommodating part in which the battery cell is accommodated; and
a cell cover member configured to form a venting portion configured to discharge a fluid generated from the first battery cell from one side of the first battery cell in a vertical direction to the outside of the cell accommodating part.

2. The battery module of claim 1, wherein the cell cover member includes:
a cover body configured to support the first battery cell; and
a cover part disposed to cover the one side of the first battery cell in the vertical direction and formed to be cut off from the cover body by pressure of the fluid generated from the first battery cell.

3. The battery module of claim 2, wherein the cover body includes a blocking part disposed between the first battery cell and the second battery cell to separate the first battery cell and the second battery cell from each other.

4. The battery module of claim 2, wherein the cell cover member further includes a guide cutoff portion configured to extend along a periphery of the cover part.

5. The battery module of claim 2, wherein the cell cover member further includes a first guide cutoff portion provided on the cover part and configured to extend in a first direction and a second guide cutoff portion configured to extend in a second direction crossing the first direction.

6. The battery module of claim 2, wherein the cell cover member further includes a guide cutoff portion provided on the cover body and configured to extend in a lengthwise direction of the cover body.

7. The battery module of claim 1, further comprising:
a fireproof cover member provided on one side of the cell cover member in the vertical direction and configured to form a guide portion configured to discharge a fluid generated from the battery cell from the one side of the cell cover member in the vertical direction to the outside of the cell accommodating part.

8. The battery module of claim 7, wherein the fireproof cover member forms the guide portion when a fireproof cover part disposed on the one side of the cell cover member in the vertical direction and formed to be cut by pressure of the fluid generated from the battery cell is cut.

9. The battery module of claim 8, wherein the fireproof cover member further includes a fireproof guide cutoff portion configured to extend in a lengthwise direction of the fireproof cover part or in a circumferential direction of the fireproof cover part.

10. The battery module of claim 7, wherein the guide portion includes a hole formed in the fireproof cover member.

11. The battery module of claim 7, wherein a thickness of the cell cover member in the vertical direction or a horizontal direction is smaller than a thickness of the fireproof cover member in the vertical direction or the horizontal direction.

12. The battery module of claim 2, wherein the battery cell further includes a third battery cell provided on an opposite side to the second battery cell with respect to the first battery cell in a horizontal direction and covered by the cover body together with the first battery cell, and
wherein the cover body includes a first blocking part disposed between the first battery cell and the second battery cell and a second blocking part configured to cover an opposite side of the third battery cell opposite to one side of the third battery cell configured to face toward the first battery cell, wherein the second blocking part corresponds to the first blocking part.

13. The battery module of claim 12, wherein a support member is provided between the first battery cell and the third battery cell.

14. The battery module of claim 13, wherein the support member is implemented with a surface pressure member or a fireproof sheet.

15. The battery module of claim 1, wherein the cell cover member includes:
a first cell cover member configured to support the first battery cell; and
a second cell cover member configured to support the second battery cell disposed on one side of the first battery cell configured to face in a horizontal direction, wherein the second cell cover member is provided on one side of the first cell cover member in the horizontal direction, and
wherein a support member is disposed between the first cell cover member and the second cell cover member.

16. The battery module of claim 1, wherein the module frame further includes a first side frame and a second side frame disposed parallel to each other to horizontally apply pressure to the battery cell from opposite sides of the battery cell configured to face in a horizontal direction.

17. The battery module of claim 16, wherein the cell cover member is disposed between the first side frame and the second side frame and covers an upper side of the first battery cell, and
wherein an upper side of the cell cover member is open.

18. The battery module of claim 1, wherein the battery cell further includes a third battery cell provided on an opposite side to the second battery cell with respect to the first battery cell in a horizontal direction, and
wherein the cell cover member includes:
a blocking part disposed between the first battery cell and the third battery cell to separate the first battery cell and the third battery cell from each other; and
a cell opening formed such that one surface of the first battery cell configured to face toward the second battery cell is open.

19. The battery module of claim 12, wherein the cover body further includes a base part configured to connect the first blocking part and the second blocking part and cover an opposite side of the first battery cell in the vertical direction.

20. The battery module of claim 3, wherein the cover body includes:
a first cover part configured to extend from the blocking part to cover the one side of the first battery cell in the vertical direction; and
a second cover part configured to extend from the blocking part to cover one side of the second battery cell in the vertical direction.

21. The battery module of claim 1, further comprising:
a sensing board disposed between the module frame and the battery cell; and
a partition wall disposed between the module frame and the sensing board.

22. The battery module of claim 21, wherein the partition wall is connected to the sensing board and extends from the sensing board toward the module frame.

23. The battery module of claim 21, wherein the partition wall is connected to the module frame and extends from the module frame toward the sensing board.

24. The battery module of claim 1, wherein a fireproof pad or a fireproof material is provided between the module frame and the battery cell.

25. A cell cover member comprising:
a cover body configured to support a first battery cell; and
a cover part connected to the cover body, wherein to prevent a fluid generated from the first battery cell from flowing to a second battery cell distinguished from the first battery cell, the cover part is separated from the cover body by pressure of the fluid to form a venting portion configured to discharge the fluid to the outside of the cover body.
